(19) United States
(12) Patent Application Publication
(10) Pub. No.: US 2026/0143512 A1
(43) Pub. Date: May 21, 2026

(54) ENHANCED CHANNEL ACCESS FOR LOW LATENCY TRANSMISSIONS

(71) Applicant: MEDIATEK INC., Hsinchu City (TW)

(72) Inventors: James Chih-Shi YEE, San Jose, CA (US); Yonggang FANG, San Jose, CA (US); Kai Ying LU, San Jose, CA (US); Li-Hsiang SUN, San Jose, CA (US); Yongho SEOK, San Jose, CA (US)

(21) Appl. No.: 19/121,262

(22) PCT Filed: Jan. 8, 2024
(86) PCT No.: PCT/CN2024/071045

§ 371 Date: Apr. 15, 2025

Related U.S. Application Data
(60) Provisional application No. 63/479,001, filed on Jan. 9, 2023.
(60) Provisional application No. 63/519,850, filed on Aug. 16, 2023.

(51) Int. Cl. H04W 72/512; H04W 74/00

(52) U.S. Cl. CPC H04W 72/512; H04W 74/006

(57) ABSTRACT

Techniques pertaining to TXOP control transfer for Wi-Fi STAs and APs are described. An apparatus may receive a frame from a station (STA) of multiple STAs that has acquired a transmission opportunity (TXOP) to perform uplink (UL) transmissions to the apparatus, wherein the multiple STAs are associated with the apparatus and the frame includes a request to transfer a control of the TXOP from the STA to the apparatus. The apparatus then sends a trigger frame in response to the frame that at least triggers the STA to perform an UL transmission to the apparatus following the apparatus acquiring the control of the TXOP from the STA. Other methods enable the transfer of the control of TXOP in the middle of the TXOP via a preemptive access.

### CROSS REFERENCE TO RELATED PATENT APPLICATIONS

The present disclosure is part of a non-provisional patent application claiming the priority benefit of U.S. Provisional Patent Application No. 63/479,001 , filed 9 Jan. 2023, and U.S. Provisional Patent Application No. 63/519,850 , filed 16 Aug. 2023, the content of which herein being incorporated by reference in their entirety.

### TECHNICAL FIELD

The present disclosure is generally related to wireless communications and, more particularly, to transmission opportunity (TXOP) control transfer for Wi-Fi stations (STAs) and access points (APs).

### BACKGROUND

Unless otherwise indicated herein, approaches described in this section are not prior art to the claims listed below and are not admitted as prior art by inclusion in this section.

Generally speaking, wireless communication traffic can be periodic or non-periodic. Periodical communication traffic may be predictable and scheduled for transmission in advance, while non-periodic communication traffic, such as a burst data packet, may arrive from an upper layer application randomly. Thus, it may be difficult to predict the arrival time of such non-periodic traffic. Furthermore, traffic associated with high priority events are typically non-periodic, unpredictable, and may have urgent delivery time bound requirement. For example, high priority events may include a safety event, an emergency event, a multi-technology in-device coexistence event, or a roaming related message, etc.

Wi-Fi IEEE 802.11 channel access is a contention-based mechanism. This means that once a particular station acquires a wireless medium resource, the particular station takes ownership of the corresponding transmission opportunity (TXOP). Other stations are generally required to set their network allocation vectors (NAVs) to protect the TXOP of the particular station and contend for the wireless medium resource after the particular station completes the TXOP if the other stations need to transmit. However, such a contention-based mechanism may create problems with respect to the transmission of low latency traffic or high priority events by stations. Therefore, there is a need for techniques that enable TXOP control transfer for Wi-Fi STAs and APs.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods, and apparatuses pertaining to TXOP control transfer for Wi-Fi STAs and APs.

In one aspect, an apparatus may include a transceiver configured to communicate wirelessly and a processor coupled to the transceiver. The processor may receive a frame from a STA of multiple STAs that has acquired a TXOP to perform uplink (UL) transmissions to the apparatus, wherein the multiple STAs are associated with the apparatus and the frame includes a request to transfer a control of the TXOP from the STA to the apparatus. The processor may further send a trigger frame in response to the frame that at least triggers the STA to perform a UL transmission to the apparatus following the apparatus acquiring the control of the TXOP from the STA.

In another aspect, a method may include sending, from an AP or a first STA of multiple STAs that are associated with the AP, a frame that includes an indication that a TXOP of the first STA is preemptible during the TXOP of the first STA. The method may also include receiving, at the AP, at least a high priority UL transmission from a second STA of the multiple STAs during the TXOP of the first STA, wherein the multiple STAs are configured to check the indication of the frame to determine whether the TXOP of the first STA is preemptible before preempting the TXOP to send high priority UL transmissions to the AP.

It is noteworthy that, although the description provided herein may be in the context of certain radio access technologies, networks and network topologies such as Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 illustrates a first scenario related to a TXOP control transfer from an STA to an AP during a TXOP.

FIG. 3a illustrates a first implementation of a second scenario related to a TXOP control transfer from an STA to an AP that occurs during a TXOP.

FIG. 3b illustrates a second implementation of a second scenario related to a TXOP control transfer from an STA to an AP that occurs during a TXOP.

FIG. 3c illustrates a third implementation of a second scenario related to a TXOP control transfer from an STA to an AP that occurs during a TXOP.

FIG. 4 illustrates a third scenario related to a TXOP control transfer from an STA to an AP that occurs during a TXOP.

FIG. 5 illustrates a fourth scenario related to a TXOP control transfer from an STA to an AP that occurs during a TXOP.

FIG. 6 illustrates a fifth scenario related to a TXOP control transfer from an STA to an AP that occurs during a TXOP.

FIG. 7 illustrates a sixth scenario related to a TXOP control transfer from an STA to an AP that occurs during a TXOP.

FIG. 8 illustrates a seventh scenario related to a TXOP control transfer from an STA to an AP that occurs during a TXOP.

FIG. 9 illustrates an eighth scenario related to a TXOP control transfer from an STA to an AP that occurs during a TXOP.

FIG. 10 illustrates a ninth scenario related to a TXOP control transfer from an STA to an AP that occurs during a TXOP.

FIG. 11 illustrates a tenth scenario related to a TXOP control transfer from an STA to an AP that occurs during a TXOP.

FIG. 12 illustrates a first scenario related to a TXOP control transfer from an STA to an AP that occurs in the middle of a TXOP via preemptive access.

FIG. 13 illustrates a second scenario related to a TXOP control transfer from an STA to an AP that occurs in the middle of a TXOP via preemptive access.

FIG. 14 illustrates a third scenario related to a TXOP control transfer from an STA to an AP that occurs in the middle of a TXOP via preemptive access.

FIG. 15 illustrates a fourth scenario related to a TXOP control transfer from an STA to an AP that occurs in the middle of a TXOP via preemptive access.

FIG. 16 illustrates a fifth scenario related to a TXOP control transfer from an STA to an AP that occurs in the middle of a TXOP via preemptive access.

FIG. 17 illustrates a sixth scenario related to a TXOP control transfer from an STA to an AP that occurs in the middle of a TXOP via preemptive access.

FIG. 18 is a block diagram of an example communication system in accordance with various implementations of the present disclosure.

FIG. 19 is a flowchart of a first example process in accordance with various implementations of the present disclosure.

FIG. 20 is a flowchart of a second example process in accordance with various implementations of the present disclosure.

FIG. 21 is a flowchart of a third example process in accordance with various implementations of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to TXOP control transfer for Wi-Fi STAs and APs. According to the present disclosure, a number of possible solutions may be implemented separately or jointly. That is, although these possible solutions may be described below separately, two or more of these possible solutions may be implemented in one combination or another.

The contention-based Wi-Fi IEEE 802.11 channel access may create problems with respect to the transmission of low latency traffic or high priority events by Wi-Fi stations (STAs). For example, in applications such as augmented reality (AR)/virtual reality (VR) or industrial Internet-of-things (IoT), the transmission of data traffic by STAs may need to meet specific delay bound, jitter, and throughput requirements despite the contention-based nature of Wi-Fi IEEE 802.11 channel access. In another example, STAs may also need to meet priority and delay bound requirements for high priority events, such as safety events, emergency events, multi-technology in-device coexistence notification events, etc. regardless of the contention-based nature of Wi-Fi IEEE 802.11 channel access. In another example, a roaming STA may need to meet priority and delay bound requirements to communicate with the serving AP and/or a target AP the roaming related messages and data. In other words, when a Wi-Fi station has low latency data or a high priority message pending for immediate transmission but does not have a TXOP, it may be very difficult for the station to meet various data delivery quality of service (QOS) requirements if the station has to wait for the completion of a current TXOP by another station and then contends for the next transmission opportunity.

In accordance with the present disclosure, since an AP can manage a wireless medium resource more efficiently than STAs, a STA may transfer TXOP control to an AP either at the beginning of a TXOP in the middle of a TXOP, or after the transmission completion but before the end of the TXOP via a request to trigger. Furthermore, the STA may also transfer the TXOP control to the AP or in the middle of a TXOP via a preemptive access. Further in accordance with the present disclosure, when a STA obtained a TXOP, the STA is configured to: (1) request an AP to schedule its uplink (UL) traffic and manage the wireless medium resource during the TXOP; (2) allow a latency sensitive traffic or high priority message to be delivered by its delay bound with high reliability; (3) permit the TXOP to be preempted by low latency data or a high priority message; (4) allow, during the TXOP, transmission of a signal from another station with urgent low latency data pending for transmission or a high priority message to the AP for preempting a current TXOP; (5) allow, during the TXOP, transmission by another station of the urgent low latency data or high priority message via preempting/deferring the on-going transmissions controlled by the AP; and (6) allow the AP to take the control of the TXOP via sending a trigger frame for scheduling the UL transmissions of urgent low latency data, high priority message, and/or the on-going transmissions either at the beginning of the TXOP, in the middle of the TXOP, or after the transmission completion but before the end of the TXOP. Thus, it is believed that various solutions and schemes proposed herein may address or otherwise alleviate issues of STAs failing to meet data delivery QoS requirements for certain low latency data or high priority messages due to the contention-based nature of Wi-Fi IEEE 802.11 channel access.

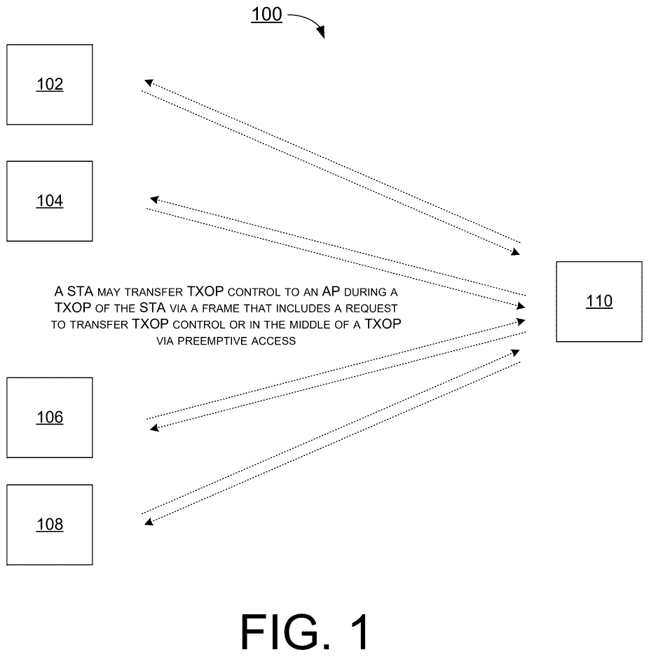

FIG. 1 illustrates an example network environment 100 in which various solutions and schemes in accordance with the present disclosure may be implemented. FIG. 1-FIG. 21 illustrate examples of implementation of various proposed schemes in network environment 100 in accordance with the present disclosure. The following description of various proposed schemes is provided with reference to FIG. 1-FIG. 21.

Referring to FIG. 1, network environment 100 may include multiple STAs (e.g., STAs 102, 104, 106, 108) being associated and communicating wirelessly with an AP 110. Under various proposed schemes in accordance with the present disclosure, a STA (e.g., STA 102) may transfer TXOP control to an AP (e.g., AP 110) either at the beginning of a TXOP, in the middle of a TXOP, or after the transmission completion but before the end of a TXOP, via a frame that includes request to transfer TXOP control or in the middle of a TXOP via a preemptive access.

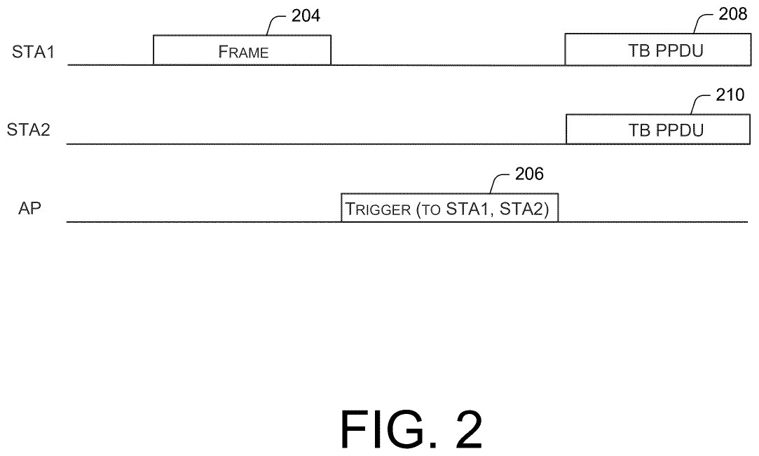

FIG. 2-FIG. 11 illustrate proposed schemes in which a TXOP control transfer from an STA to an AP occurs during a TXOP. FIG. 2 illustrates a scenario in which an AP may improve spectrum efficiency by using the UL orthogonal frequency-division multiple access (OFDMA) and aggregate PHY protocol data unit (A-PPDU) mechanisms. As shown in FIG. 2, two stations, STA1 and STA2, are associated with an AP. Initially, STA1 may acquire the use of a wireless medium resource, also referred to as a medium. After STA1 has acquired the medium and the corresponding TXOP, STA1 may send a frame 204 to the AP to request that the AP trigger the uplink transmission for STA1, in which the frame 204 also includes a request to transfer the control of the TXOP to the AP. Because the AP has more control over various mediums and has knowledge about the needs of other stations (e.g., STA2) to transmit uplink data (e.g., data that is currently buffered by the other stations, such as STA2), the AP may send a trigger frame 206 to STA1 and STA2 in response to the frame 204. Furthermore, in response to the trigger frame 206, STA1 may send trigger-based (TB) PPDU 208 to the AP, and STA2 may simultaneously send TB PPDU 210 to the AP. As used herein, simultaneous means completely or at least partially overlap in time. In this way, the AP not only triggers STA1 to perform an uplink transmission to the AP, but also simultaneously triggers STA2 to perform an uplink transmission to the AP.

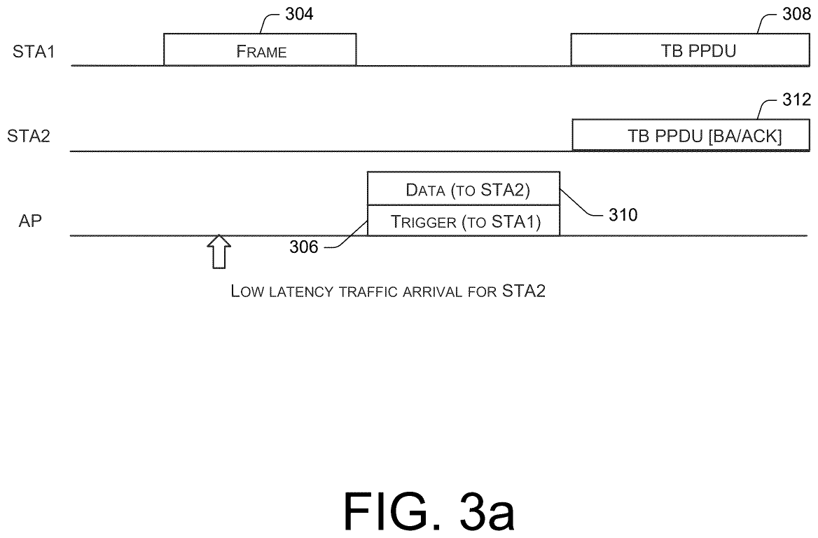

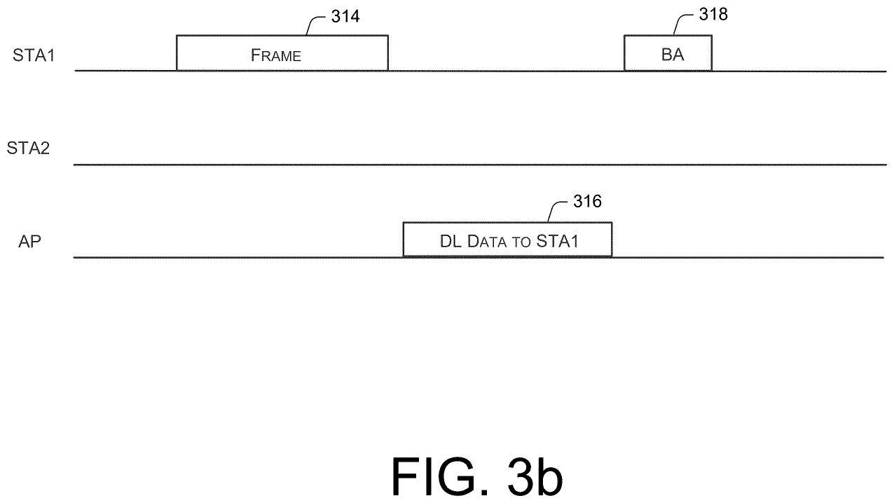

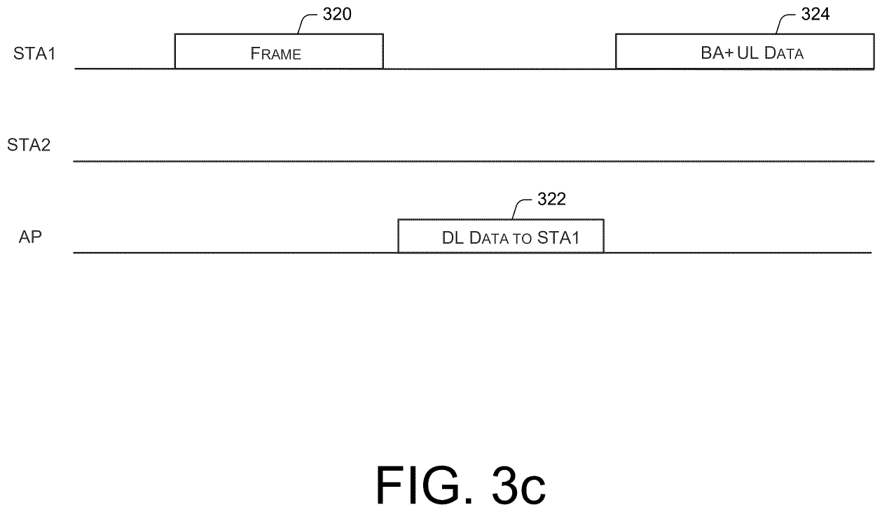

FIG. 3a illustrates a first implementation of scenario in which an AP may accommodate a low latency traffic from another STA while serving the UL traffic of the TXOP holder STA. As shown in FIG. 3a, two stations, STA1 and STA2, are associated with an AP. Initially, STA1 may acquire the use of a medium. After STA1 has acquired the medium and the corresponding TXOP, STA1 may send a frame 304 to the AP to request that the AP trigger the uplink transmission for STA1, in which the frame 304 also includes a request to transfer the control of the TXOP to the AP.

During the reception of the frame 304, the AP may also receive low latency downlink (DL) traffic for delivery to STA2. Subsequently, in response to the frame 304, the AP may send a trigger frame 306 to trigger STA1 to send TB PPDU 308 to the AP, while simultaneously sending a DL transmission (e.g., data frame 310) that includes the low latency traffic to STA2. In return, STA2 may send a TB PPDU 312 that includes an acknowledgment of the data frame 310.

FIG. 3b illustrates a second implementation of scenario in which an AP may accommodate a low latency traffic from a connected distributed system (DS) or another STA while serving the UL traffic of the TXOP holder STA. As shown in FIG. 3b, two stations, STA1 and STA2, are associated with an AP. Initially, STA1 may acquire the use of a medium. After STA1 has acquired the medium and the corresponding TXOP, STA1 may send a frame 314 to the AP to request that the AP trigger the uplink transmission for STA1, in which the frame 314 also includes a request to transfer the control of the TXOP to the AP. At this time, the AP may have buffered DL traffic 316, i.e., buffered low latency data addressing to STAI from the DS or another associated STA, for delivery to STA1. Accordingly, in response to the frame 314, the AP may send a data frame that includes the buffered DL traffic 316 to STA1. Subsequently, the STA1 may send a block acknowledgment (BA) 318 to the AP.

FIG. 3c illustrates a third implementation of scenario in which an AP may accommodate a low latency traffic from the connected DS or another STA while serving the UL traffic of the TXOP holder STA. As shown in FIG. 3c, two stations, STA1 and STA2, are associated with an AP. Initially, STA1 may acquire the use of a medium. After STA1 has acquired the medium and the corresponding TXOP, STA1 may send a frame 320 to the AP to request that the AP trigger the uplink transmission for STA1, in which the frame 320 also includes a request to transfer the control of the TXOP to the AP. At this time, the AP may have buffered DL traffic 322, i.e., buffered low latency data addressing to STA1 from the DS or another associated STA, for delivery to STA1. Accordingly, in response to the frame 320, the AP may send a data frame that includes the buffered DL traffic 322 to STA1. Subsequently, the STA1 may send a frame 324 that includes a BA and UL traffic to the AP.

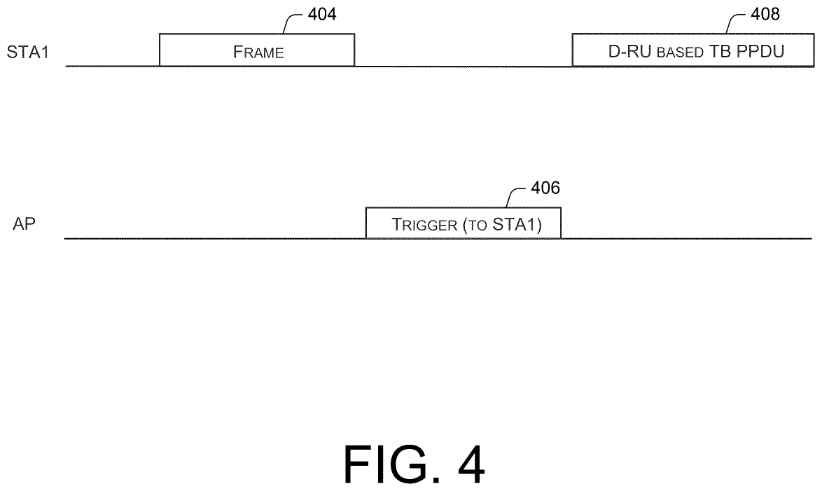

FIG. 4 illustrates a scenario in which an AP may allocate a specific type of resource unit (RU) and/or modulation coding scheme (MCS) to an STA to improve transmission reliability. As shown in FIG. 4, STA1 is associated with an AP. Initially, STA1 may acquire the use of a medium. After STA1 has acquired the medium and the corresponding TXOP, STA1 may send a frame 404 to the AP to request that the AP trigger the uplink transmission for STA1, in which the frame 404 also includes a request to transfer the control of the TXOP to the AP. In response to the frame 404, the AP may send a trigger frame 406 that triggers the STAI to send an uplink transmission that includes a distributed resource unit (D-RU) based TB PPDU to the AP. The D-RU may enable STA1 to avoid interference while sending the uplink transmission to the AP.

Thus, as shown in FIGS. 2-4, an STA may transmit a frame to an AP that includes a request to transfer the control of the TXOP to the AP after obtaining a TXOP. After receiving the frame, the AP allocates a RU to the STA by sending a trigger frame. Meanwhile, the AP is able to serve other low latency DL traffic and/or UL traffic from one or more other STAs.

In various embodiments, the frame may indicate parameters that are related to TXOP. A first parameter is a remaining TXOP duration. For example, if a TXOP duration field of the frame is set to a predetermined value (e.g., 0), single frame exchange is allowed (i.e., AP may send only one trigger frame in response to a frame). However, if the TXOP duration field is set to a non-zero value, then multiple frame exchange is allowed (i.e., AP may send more than one trigger frame in response to a frame). A second parameter is a bandwidth of the TXOP, which is equivalent to available channels at the STA side. A third parameter is a UL RU allocation parameter that indicates a RU size and a RU type of the RU that is to be allocated to the TXOP holder STA by the AP. For example, the RU type may be regular-RU, multi-RU, distributed-RU, etc. The fourth parameter is the UL time allocation, which is the transmission time to be allocated to the TXOP holder STA during the TXOP.

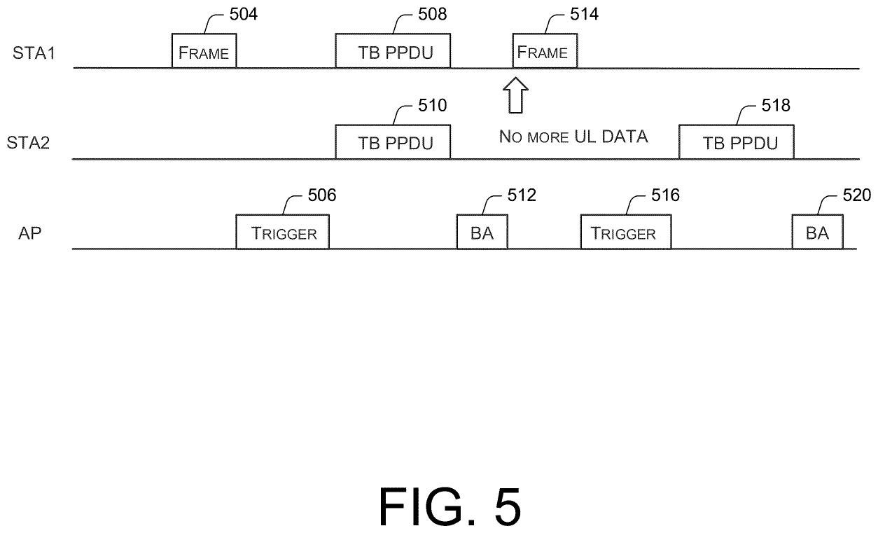

FIG. 5 illustrates an STA initiated TXOP control transfer trigger operation that implements a single trigger frame exchange sequence. In this sequence, an STA may send one or more frames within a TXOP, and the TXOP duration field in each frame is set to 0. As shown in FIG. 5, two stations, STA1 and STA2, are associated with an AP. Initially, STA1 may acquire the use of a medium. After STA1 has acquired the medium and the corresponding TXOP, STA1 may send a frame 504 to the AP to request that the AP trigger the uplink transmission for STA1, in which the frame 504 also includes a request to transfer the control of the TXOP to the AP.

Subsequently, in response to the frame 504, the AP may send a trigger frame 506 to STAI and STA2. In response to the trigger frame 506, STA1 may send TB PPDU 508 to the AP, and STA2 may simultaneously send TB PPDU 510 to the AP. In this way, the AP not only triggers STA1 to perform an uplink transmission to the AP, but also simultaneously triggers STA2 to perform an uplink transmission to the AP.

In response to the TB PPDU 508 and the TB PPDU 510, the AP may send BA frame 512 to STA1 and STA2. At this point, STA1 may want the AP to maintain control over the TXOP. As such, STA1 may send another frame 514 to the AP during the TXOP. The frame 514 may indicate to the AP that STA1 has no additional uplink data to transmit to the AP. Consequently, after receiving the frame 514 with the indication, the AP may determine that there is no need to schedule any uplink transmission RUs for STA1. Accordingly, the AP may send a trigger frame 516 to STA2 that allocates a TB PPDU 518 to STA2 for the uplink transmission of STA2. In response to receiving the TB PPDU 518, the AP may send a BA frame 520 to STA2.

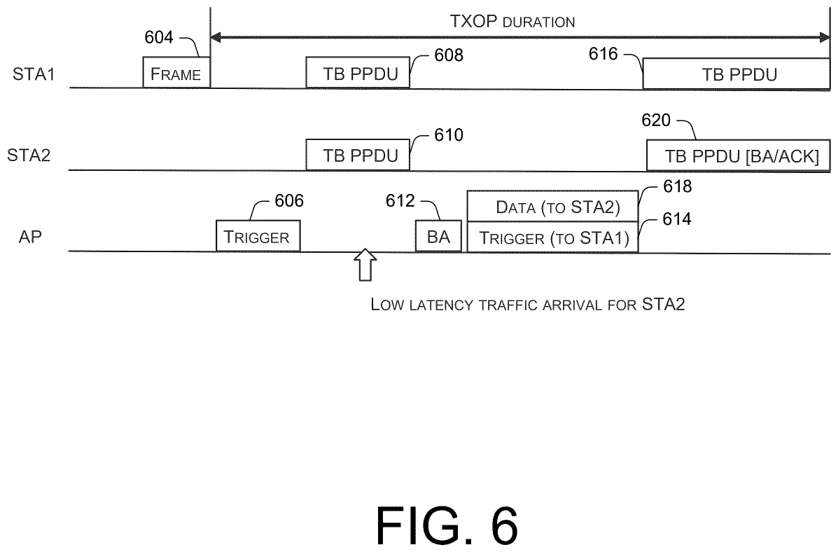

FIG. 6 illustrates an STA initiated TXOP control transfer trigger operation that implements a multiple trigger frame exchange sequence. In this sequence, an STA may only need to send one frame within a TXOP, and the TXOP duration field in the frame is set to a non-zero value. As shown in FIG. 6, two stations, STA1 and STA2, are associated with an AP. Initially, STA1 may acquire the use of a medium. After STA1 has acquired the medium and the corresponding TXOP, STAI may send a frame 604 to the AP to request that the AP trigger the uplink transmission for STA1, in which the frame 604 also includes a request to transfer the control of the TXOP to the AP.

Subsequently, in response to the frame 604, the AP may send a trigger frame 606 to STA1 and STA2. In response to the trigger frame 606, STA1 may send TB PPDU 608 to the AP, and STA2 may simultaneously send TB PPDU 610 to the AP. In this way, the AP not only triggers STA1 to perform an uplink transmission to the AP, but also simultaneously triggers STA2 to perform an uplink transmission to the AP. In response to the TB PPDU 608 and the TB PPDU 610, the AP may send BA frame 612 to STA1 and STA2.

However, during the reception of TB PPDU 608 and TB PPDU 610, the AP may also receive low latency downlink (DL) traffic for delivery to STA2. Accordingly, the AP may send a trigger frame 614 to trigger STA1 to send another TB PPDU 616 to the AP, while simultaneously sending the DL data frame 618 that includes the low latency traffic to STA2. In return, STA2 may send a TB PPDU 620 that includes an acknowledgment of the data frame 618.

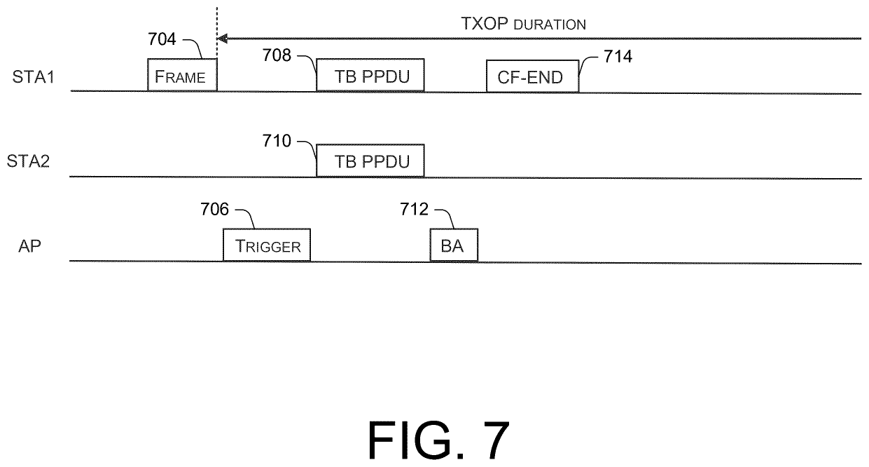

FIG. 7 illustrates an STA initiated TXOP control transfer trigger operation in which a TXOP truncation is implemented for a single trigger frame sequence. In such a sequence, the TXOP holder STA may send a contention free (CF)-END frame to truncate the TXOP. As shown in FIG. 7, two stations, STA1 and STA2, are associated with an AP. Initially, STA1 may acquire the use of a medium. After STA1 has acquired the medium and the corresponding TXOP, STA1 may send a frame 704 to the AP to request that the AP trigger the uplink transmission for STA1, in which the frame 704 also includes a request to transfer the control of the TXOP to the AP.

Subsequently, the AP may send a trigger frame 706 to STA1 and STA2. In response to the trigger frame 706, STA1 may send TB PPDU 708 to the AP, and STA2 may simultaneously send TB PPDU 710 to the AP. In this way, the AP not only triggers STA1 to perform an uplink transmission to the AP, but also simultaneously triggers STA2 to perform an uplink transmission to the AP. In response to the TB PPDU 708 and the TB PPDU 710, the AP may send BA frame 712 to STAI and STA2. At this point, STAI may decide to terminate the TXOP by sending a CF-END frame 714 during the duration of the TXOP.

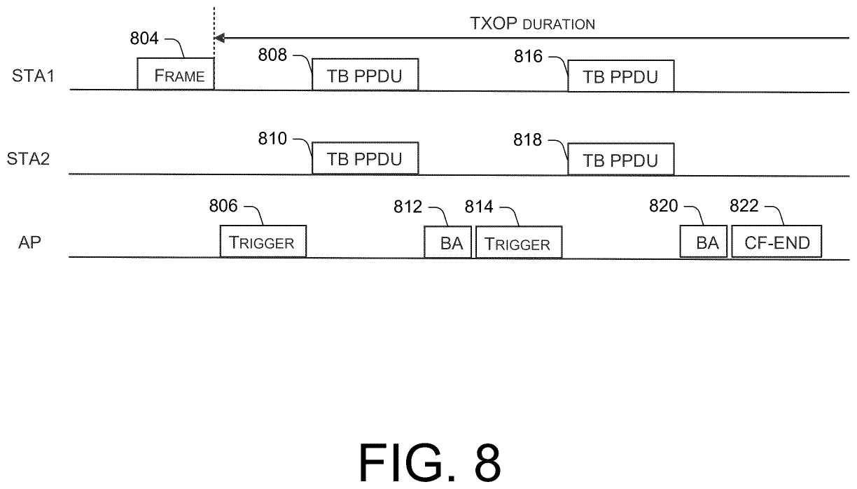

FIG. 8 illustrates an STA initiated TXOP control transfer trigger operation in which a TXOP truncation for a multiple trigger frame sequence is implemented. In such a sequence, the AP may send a CF-END frame to truncate the TXOP. As shown in FIG. 8, two stations, STA1 and STA2, are associated with an AP. Initially, STA1 may acquire the use of a medium. After STA1 has acquired the medium and the corresponding TXOP, STA1 may send a frame 804 to the AP to request that the AP trigger the uplink transmission for STA1, in which the frame 804 also includes a request to transfer the control of the TXOP to the AP.

Subsequently, the AP may send a trigger frame 806 to STA1 and STA2. In response to the trigger frame 806, STA1 may send TB PPDU 808 to the AP, and STA2 may simultaneously send TB PPDU 810 to the AP. In this way, the AP not only triggers STA1 to perform an uplink transmission to the AP, but also simultaneously triggers STA2 to perform an uplink transmission to the AP. In response to the TB PPDU 808 and the TB PPDU 810, the AP may send BA frame 812 to STA1 and STA2.

After the sending of the BA frame 812 to STA1 and STA2, the AP may once again send a trigger frame 814 to STA1 and STA2. In response to the trigger frame 814, STA1 may send TB PPDU 816 to the AP, and STA2 may simultaneously send TB PPDU 818 to the AP. In this way, the AP once again triggers STA1 to perform an uplink transmission to the AP and simultaneously triggers STA2 to perform an uplink transmission to the AP. In response to the TB PPDU 816 and the TB PPDU 818, the AP may send BA frame 820 to STA1 and STA2. At this point, the AP may decide to terminate the TXOP by sending a CF-END frame 822 to STA1 and STA2 during the duration of the TXOP.

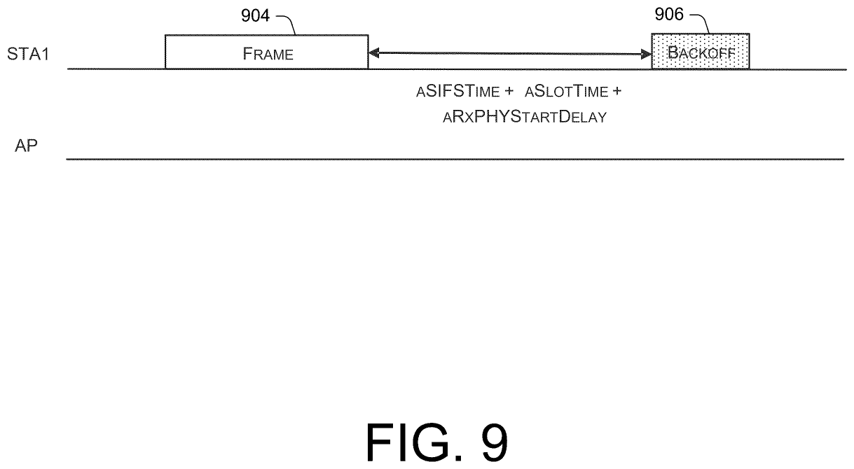

FIG. 9 illustrates an error recovery for an STA initiated TXOP control transfer trigger operation. As shown in FIG. 9, STA1 is in communication with an AP. Initially, STA1 may acquire the use of a medium. After STAI has acquired the medium and the corresponding TXOP, STA1 may send a frame 904 to the AP to request that the AP trigger the uplink transmission for STA1, in which the frame 904 also includes a request to transfer the control of the TXOP to the AP.

However, after sending the frame 904, if STA1 does not receive a PHY-RXSTART.indication primitive during a predetermined timeout interval starting at the end of the PPDU containing the frame 904, STA1 may conclude that the transmission of the frame 904 has failed and invoke a backoff procedure, e.g., backoff 906, to terminate the TXOP control transfer. In some instances, the predetermined timeout interval may be a sum of aSIFSTime, aSlotTime, and aRxPHYStartDelay.

In some implementations, when a TXOP holder STA is associated with a non-transmitted basic service set identifier (BSSID), the receiver address (RA) field (i.e., Address 1 in the MAC header) of a frame that includes the request to transfer the TXOP control may be set to its associated non-transmitted BSSID. Alternatively, the RA field may be set to the transmitted BSSID if the TXOP holder STA has set the Rx Control Frame To MultiBSS subfield in its transmitted HE MAC Capabilities Information field to 1. Thus, if the RA of the frame is set to the non-transmitted BSSID, the AP that receives the frame may schedule the wireless medium resource to the STA that is associated with the same BSSID. Otherwise, the AP may schedule the wireless medium resource to any associated STA of the BSSID.

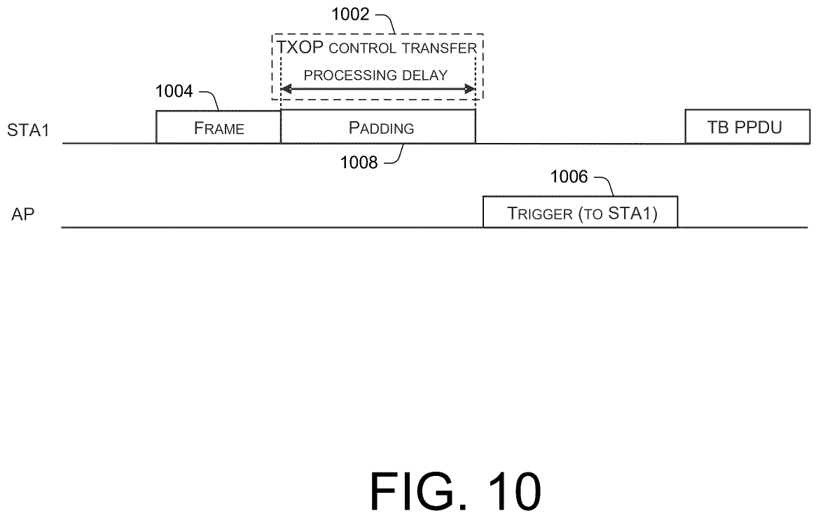

As shown in FIG. 10, an AP that supports STA initiated TXOP control transfer trigger operations may declare a TXOP control transfer processing delay 1002. The TXOP control transfer processing delay 1002 provides the AP with time to schedule wireless medium resources after receiving a frame 1004 from an STA (e.g., STA1) that includes the request to transfer the TXOP control, and represents the processing time until the AP is able to schedule one or more trigger frames (e.g., trigger frame 1006) after receiving the frame that includes the request. Thus, when the TXOP control transfer processing delay 1002 declared by the AP is a non-zero value, the TXOP holder STA is configured to include a corresponding MAC/PHY padding 1008 for the TXOP control transfer processing delay 1002.

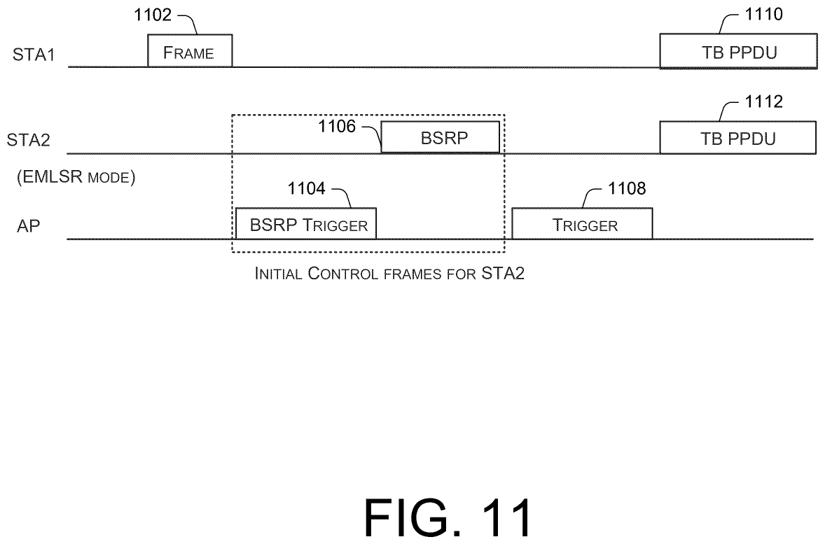

As shown in FIG. 11, an AP that supports STA initiated TXOP control transfer trigger operations may need to exchange control information with one or more additional STAs other than the TXOP holder STA after receiving a frame that includes a request for TXOP transfer from the TXOP holder STA. For example, such control information may include null data packet (NDP) sounding frames, multi-user request-to-send (MU-RTS) trigger frames, buffer status report poll (BSRP) trigger frames, initial control frames for the enhanced multilink single-radio (EMLSR) mode, etc. Accordingly, the AP may first exchange frames with the one or more additional STAs before soliciting the UL traffic from the TXOP holder STA, i.e., sending a trigger frame to the TXOP holder STA. However, in such a case, the AP is configured to allocate the wireless medium resource requested via the frame to the TXOP holder STA while the exchange of control information takes place.

For example, as shown in FIG. 11, STA1 may send a frame 1102 that includes a request to transfer the control of the TXOP to the AP. At this point, the AP may have no information regarding STA2. Thus, the AP may need to send a control frame to STA2 to obtain the state and/or control information of STA2. In the particular example shown in FIG. 11, the AP may send a Buffer State Report Poll (BSRP) trigger frame 1104 to STA2. In return, STA2 may provide a Buffer State Report Poll (BSR) frame 1106 back to the AP. The BSR frame 1106 may provide the AP with information regarding the state of STA2. Thus, based on such information, the AP may send trigger frame 1108 to STA1 and STA2 to trigger uplink transmissions that result in STA1 sending a TB PPDU 1110 to the AP, and STA2 simultaneously sending a TB PPDU 1112 to the AP.

In various implementations, a frame that includes a request to transfer the control of the TXOP to the AP in accordance with the present disclosure may indicate a buffer status, i.e., a queue size in a number of bytes of the STA. The frame may also indicate a delay bound, i.e., a maximum amount of time in microseconds allowed for the transport of a MAC service data unit (MSDU) or an aggregate MSDU (A-MSDU).

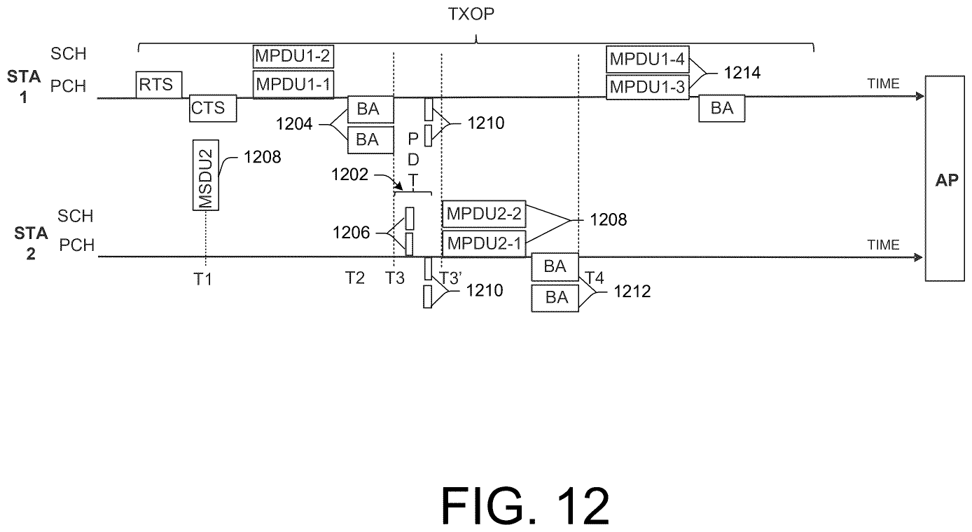

FIG. 12-FIG. 17 illustrate proposed schemes in which a TXOP control transfer from an STA to an AP occurs in the middle of a TXOP. The preemptive access offered by such transfer of a TXOP control in the middle of a TXOP may provide an STA with an intra-basic service set (BSS) network allocation vector (NAV) setting the ability to send high priority and/or low latency data to the AP in the middle of the TXOP. For example, when a STA receives within an intra-BSS NAV period low latency data or a high priority message from an upper layer with urgent delivery required by a QoS delay bound or a high priority event, the STA may send a high priority preemption request (HPPR). After receiving the HPPR, the AP may allocate a resource to the preemption requesting STA to enable the STA to transmit high priority and/or low latency data to the AP.

FIG. 12 illustrates a first example of preemptive access in the middle of a TXOP in which there is no collision during a preemption detection time (PDT). A PDT is the time period between SIFS time and PIFS time of the end of preceding transmission which allows a HPPR to be sent in the PDT. After that time period, either TXOP holder station preforms a PIFS continuation procedure or the AP transmits a control frame to enable the TXOP holder station to perform PIFS continuation procedure. As shown in FIG. 12, STA1 may be performing UL transmissions to the AP, and STA1 and the AP may have an agreement that the TXOP of STA1 may be preempted and an UL transmission of STA1 may be deferred if needed via the use of PDT. In this example, the AP may provide indications (e.g., in a MAC header of data or control frame) that indicate whether the TXOP of STA1 is preemptible. Accordingly, other STAs associated with the AP may use such indications to determine preemption permission from the AP before preempting the TXOP of STA1. The PDT is a time period during which an HPPR may be sent by another STA and detected.

As further shown in FIG. 12, as STA1 performs UL transmissions to the associated AP in its TXOP, a PDT 1202 may start at time T3 after a BA frame 1204 has been sent by the AP to STAI on both a primary channel (PCH) and a secondary channel (SCH) for a preceding UL transmission (e.g., MAC protocol data unit (MPDU) 1-1 and MPDU 1-2), and the PCH and the SCH become idle. This is because the preemption indication is carried in the BA frame 1204 sent by the AP. In this instance, the indicator in the BA frame 1204 may indicate that the TXOP of STA1 is preemptible. After STA2 hears the BA frame 1204 and becomes aware of the PDT 1202, STA2 may send an HPPR 1206 to the AP via the PCH and the SCH to indicate that STA2 has high priority and/or low latency data 1208 (e.g., MAC service data unit (MSDU) 2) to be sent to the AP. For example, STA2 may have acquired the high priority and/or low latency data 1208 at time T1 that precedes T3. At this time, STA1 may also hear the HPPR 1206 and defer its next UL transmission. For example, STA2 may send the HPPR 1206 on the PCH and the SCH in xIFS (e.g., short interframe space (SIFS)) to signal the need to preempt the subsequent UL transmissions by STA1. In such an example, STA2 may set an identifier in the HPPR (e.g., in the U-SIG of the HPPR) to identify STA2 to the AP and/or other STAs.

After the AP successfully receives the HPPR 1206, the AP may send a response to preemption request (RTPR) 1210 acknowledging the HPPR 1206 to both STA2 and STA1 via the PCH and the SCH. For example, the RTPR 1210 may be sent on the PCH and the SCH in xIFS (e.g., SIFS) accepting the preemption request from STA2.

After receiving the RTPR 1210, STA2 may send the high priority and/or low latency data 1208 to the AP on the PCH and the SCH, e.g., via MPDU 2-1 on the PCH and MDPU 2-2 on the SCH. The RTPR 1210 is also heard by STA1, which causes STA1 to defer its subsequent UL transmission. After receiving the high priority and/or low latency data from STA2, the AP may send a BA frame 1212 on the PCH and the SCH to STA2. When STA1 hears the BA frame 1212 from the AP to STA2, STA1 may continue its next UL transmission 1214 (e.g., MPDU 1-3 and MPDU 1-4), provided that the preemption permission indication is not set in a BA that responds to the transmission of the BA frame 1212.

However, if no HPPR is received from other STAs during the PDT 1202, the AP may transmit a signal (e.g., in a point coordination function inter-frame space (PIFS)) on the PCH and the SCH to indicate to STA1 to continue its UL transmission (i.e., PIFS continuation). Furthermore, if STA2 does not receive the RTPR 1210 from the AP, STA2 is prohibited from transmitting the high priority and/or low latency data 1208 to the AP. On the other hand, if STA1 does not receive the RTPR 1210 from the AP and the PCH and the SCH are still idle, STA1 can continue its UL transmissions in the PDT (i.e., PIFS).

In some instances, since the AP has control of the TXOP after the end of the PDT, the AP may have the ability to use the BA frame 1212 to further configure whether preemption is permitted or not permitted. If the AP uses the BA frame 1212 to disallow further preemption, then no additional PDT is enabled before STA1 transmits its next UL transmission (e.g., MPDU 1-3 and MPDU 1-4). However, if the AP does not use the BA frame 1212 to disable preemption, then there may be another PDT before STA1 transmits its next UL transmission (e.g., MPDU 1-3 and MPDU 1-4).

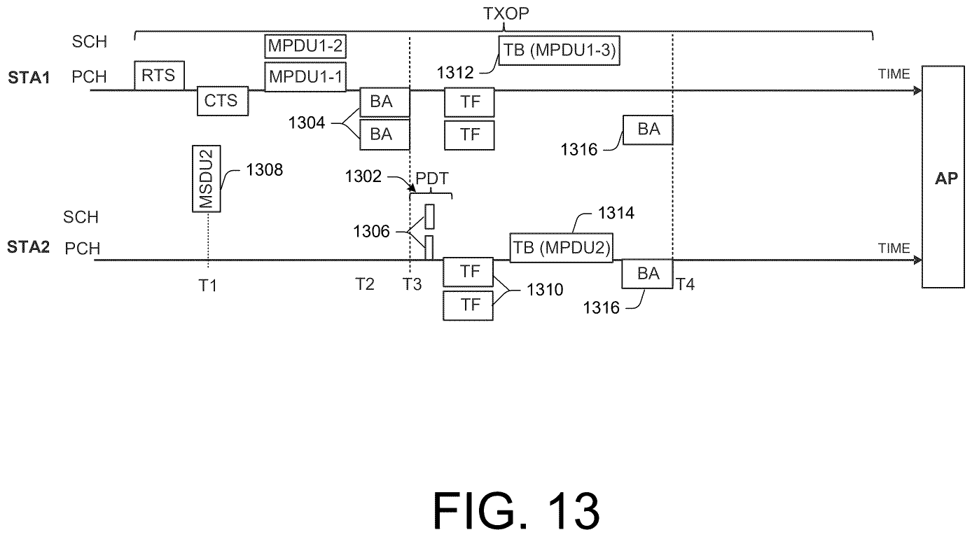

FIG. 13 illustrates a second example of preemptive access in the middle of a TXOP in which there is no collision during a PDT. As shown in FIG. 13, STA1 may be performing UL transmissions to the associated AP, and STA1 and the AP may have an agreement that the TXOP of STAI may be preempted and an UL transmission of STA1 may be deferred if needed via the use of PDT. In this example, the AP may provide indications (e.g., in a MAC header of data or control frame) that indicate whether the TXOP of STA1 is preemptible. Accordingly, other STAs associated with the AP may use such indications to determine preemption permission from the AP before preempting the TXOP of STA1.

As further shown in FIG. 13, as STA1 performs UL transmissions to the AP in its TXOP, a PDT 1302 may start at time T3 after a BA frame 1304 has been sent by the AP to STA1 on both a PCH and a SCH for a preceding UL transmission (e.g., MPDU 1-1 and MPDU 1-2), and the PCH and the SCH become idle. This is because the preemption indication is carried in the BA frame 1304 sent by the AP. In this instance, the indicator in the BA frame 1304 may indicate that the TXOP of STA1 is preemptible. After STA2 hears the BA frame 1304 and becomes aware of the PDT 1302, STA2 may send an HPPR 1306 to the AP via the PCH and the SCH to indicate that STA2 has high priority and/or low latency data 1308 (e.g., MSDU 2) to be sent to the AP. For example, STA2 may have acquired the high priority and/or low latency data 1308 at time T1 that precedes T3. At this time, STA1 may also hear the HPPR 1306 and defer its next UL transmission. For example, STA2 may send the HPPR 1306 on the PCH and the SCH in xIFS (e.g., SIFS) to signal the need to preempt the UL transmissions by STA1. In such an example, STA2 may set an identifier in the HPPR (e.g., in the U-SIG of the HPPR) to identify STA2 to the AP and/or other STAs.

After the AP successfully receives the HPPR 1306, the AP may send a trigger frame 1310 on the PCH and the SCH to STA 1 and STA2. The trigger frame 1310 may carry the information to schedule STA1 to use the SCH for its next UL transmission (e.g., MPDU 1-3), and schedule STA2 to use the PCH for its UL transmission of the high priority and/or low latency data 1308 (e.g., MPDU 2). For example, the trigger frame 1310 may be a basic trigger frame or a MU-RTS followed by CTS.

After receiving the trigger frame 1310, STA1 may continue the transmission of TB PPDU 1312 carrying UL data (e.g., MPDU 1-3) on the SCH, and STA2 may transmit a TB PPDU 1314 carrying the high priority and/or low latency data 1308 (e.g., MPDU 2) on the PCH. In response, the AP may send a BA frame 1316 to STA1 and STA2. However, if the trigger frame 1310 is not received by the STA1 and STA2, STA2 is prohibited from transmitting and STA1 continues its subsequent UL transmission on the PCH and the SCH when those channels are idle.

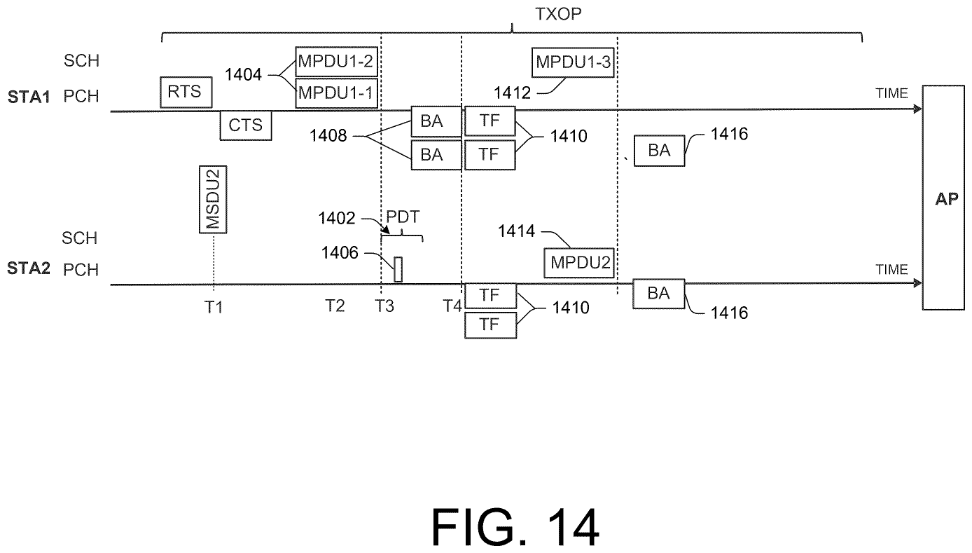

FIG. 14 illustrates a third example of preemptive access in the middle of a TXOP in which there is no collision during a PDT. As shown in FIG. 14, STA1 may be performing UL transmissions to the associated AP, and STA1 and the AP may have an agreement that the TXOP of STA1 may be preempted and a DL transmission (e.g., BA) of AP may be deferred if needed via the use of PDT. In this example, an STA (e.g., STA1) may provide indications (e.g., in a MAC header of data or control frame) that indicate whether the TXOP of STA1 is preemptible. Accordingly, other STAs associated with the AP may use such indications to determine preemption permission from the STA before preempting the TXOP of STA1.

As further shown in FIG. 14, as STA1 performs UL transmissions to the AP in its TXOP, a PDT 1402 may start at time T3 after a UL transmission (e.g., MPDU 1-1 and MPDU 1-2) has been sent by the STAI on both a PCH and a SCH to the AP and the PCH and the SCH become idle. This is because the preemption indication is carried in the MAC headers of the MPDU 1404 sent by STA1. In this instance, the indicator in the MPDU 1404 may indicate that the TXOP of STA1 is preemptible.

After STA2 hears the MPDU 1404 and becomes aware of the PDT 1402, STA2 may send an HPPR 1406 to the AP via the PCH to indicate that STA2 has high priority and/or low latency data (e.g., MSDU 2) to be sent to the AP and the subsequent UL transmission by the STA1 needs to be preempted. For example, STA2 may have acquired the high priority and/or low latency data (e.g., from an upper layer) at time T1 that precedes T3. The HPPR 1406 may be transmitted by the STA2 on the PCH in an xIFS (e.g., SIFS) after the PCH becomes idle.

After the AP successfully receives the HPPR 1406, the AP may send a BA frame 1408 on the PCH and the SCH to STA1 to acknowledge reception of the UL transmission (e.g., MPDU 1-1 and MPDU 1-2) from STA1. The AP also takes over control of the TXOP. In some implementations, the BA frame 1408 may carry an indication that a trigger frame will immediately follow. In other implementations, instead of the BA frame 1408, the AP may transmit another type of signal to STA1 to indicate that a trigger frame will immediately follow. Thus, after successfully receiving the BA frame 1408 or the other type of signal, STA1 may stay in a listening mode to receive the trigger frame.

Subsequently, the AP may follow up the BA frame 1408 with a trigger frame 1410 on the PCH and the SCH to STA 1 and STA2. The trigger frame 1410 may carry the information to schedule STA1 to use the SCH for its next UL transmission (e.g., MPDU 1-3), and schedule STA2 to use the PCH for its UL transmission of the high priority and/or low latency data (e.g., MPDU 2).

After receiving the trigger frame 1410, STA1 may continue the transmission of TB PPDU 1412 carrying UL data (e.g., MPDU 1-3) on the SCH, and STA2 may transmit a TB PPDU 1414 carrying the high priority and/or low latency data (e.g., MPDU 2) on the PCH. In response, the AP may send a BA frame 1416 to STA1 and STA2. However, if no RTPR is received in an XIFS (e.g., SIFS) during the PDT 1402, the AP may transmit the BA frame with no preemption request received indication in PIFS to STA1 (i.e., PIFS continuation). The STA1 may continue transmission of subsequent MPDU 1-3 in SIFS after BA 1408.

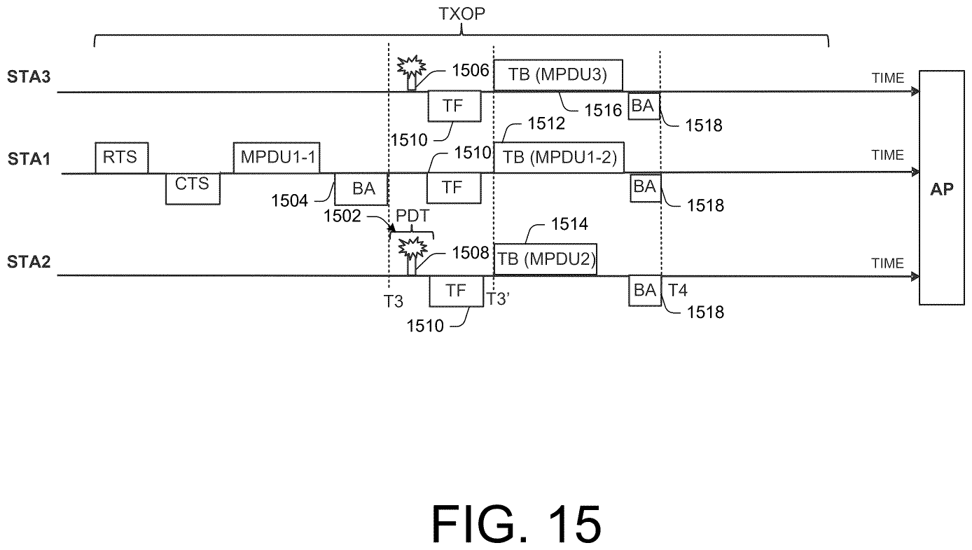

FIG. 15 illustrates a first example of preemptive access in the middle of a TXOP in which there is collision during a PDT. As shown in FIG. 15, STA1 may be performing UL transmissions to the AP, and STAI and the AP may have an agreement that the TXOP of STA1 may be preempted and an UL transmission of STA1 may be deferred if needed via the use of PDT. In this example, the AP may provide indications (e.g., in a MAC header of data or control frame) that indicate whether the TXOP of STA1 is preemptible. Accordingly, other STAs associated with the AP may use such indications to determine preemption permission from the AP before preempting the TXOP of STA1.

As further shown in FIG. 15, STA2 and STA3 may be UHR STAs that are associated with the AP but may be nodes that are hidden from each other. This means that STA2 and STA3 are not able to hear each other, but are able to hear the frame exchanges between STA1 and the AP. As STA1 performs UL transmissions to the AP in its TXOP, a PDT 1502 may start at time T3 after a BA frame 1504 has been sent by the AP to STA1 for a preceding UL transmission (e.g., MPDU 1-1), and the channel has become idle. This is because the preemption permission indication is carried in the BA frame 1504 sent by the AP. In this instance, the indicator in the BA frame 1504 may indicate that the TXOP of STA1 is preemptible.

After STA2 and STA 3 receive the BA frame 1504 and become aware of the PDT 1502, STA2 and STA3 may simultaneously send an HPPR 1506 and an HPPR 1508 in xIFS (e.g., SIFS), respectively, to the AP to indicate that they both have high priority and/or low latency data to be sent to the AP. For example, STA2 and STA3 may have both received high priority and/or low latency data (e.g., from an upper layer) and need to preempt the subsequent UL transmission from STA1 in the TXOP owned by STA1. In such an example, each of STA2 and STA3 may set an identifier in their respective HPPR (e.g., in the U-SIG of the HPPR) to identify themselves to the AP and/or other STAs. However, the HPPR 1506 and HPPR 1508 sent by STA2 and STA3 may collide with each other, resulting in the AP being able to receive the preamble of HPPRs only but unable to decode the received HPPRs (e.g., unable to decode the U-SIG fields of the HPPRs) to identify the

At this point, the AP may take over the control of the TXOP and send a trigger frame 1510 to schedule the UL transmissions of STA2 and STA3 on resource units (RUs) that are different from the RU allocated to STA1. Thus, after STA1, STA2, and STA3 receive and successfully decode the trigger frame 1510, STA1 may continue transmission of TB PPDU 1512 carrying MPDU 1-2 on the assigned RU. However, STA2 and STA3 have to simultaneously use UL OFDMA random access (UORA) to transmit on the assigned RUs TB PPDUs 1514 and 1516 that carry their MPDU 2 and MPDU 3, respectively. This means that the high priority and/or low latency data are transmitted by the STA2 and STA3 to the AP on a random basis. In response, the AP may send a BA frame 1518 that acknowledges the reception of data from STA1, STA2, and STA3. Alternatively, STA2 and STA3 may use the BSRP/BSR mechanism to further identify themselves to the AP before transmitting high priority and/or low latency data, such that the AP may arrange subsequent UL transmission times for the transmission of the high priority and/or low latency data of STA2 and STA3 to the AP. However, if STA2 is unable to successfully receive and decode the trigger frame 1510, STA2 is prohibited from transmitting its high priority and/or low latency data. Likewise, if STA3 is unable to successfully receive and decode the trigger frame 1510, STA3 is prohibited from transmitting its high priority and/or low latency data. Nevertheless, if STA1 is unable to successfully receive and decode the trigger frame 1510, STA1 can continue its UL transmission when the channel is idle in SIFS time.

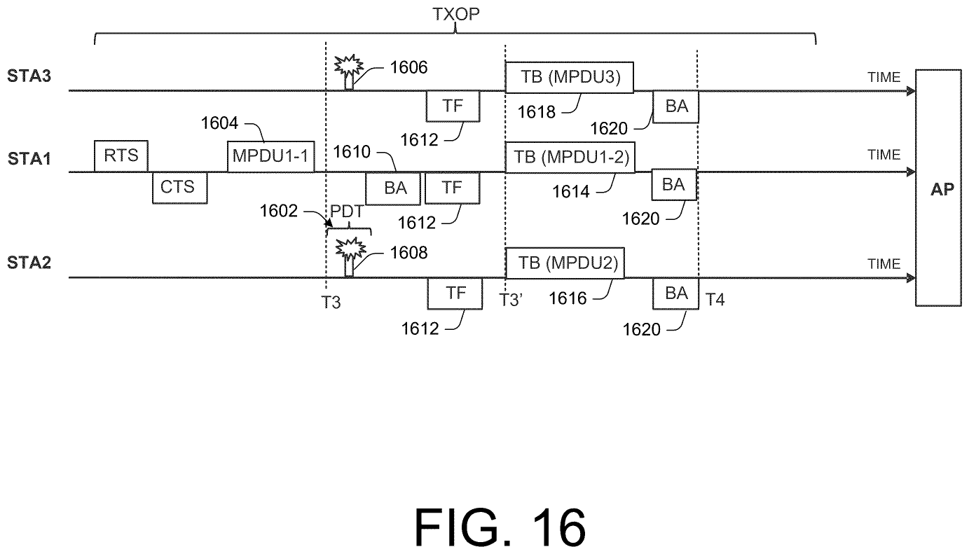

FIG. 16 illustrates a second example of preemptive access in the middle of a TXOP in which there is a collision during a PDT. As shown in FIG. 16, STA1 may be performing UL transmissions to the AP, and STAI and the AP may have an agreement that the TXOP of STA1 may be preempted and a DL transmission of AP may be deferred if needed via the use of PDT. In this example, an STA (e.g., STA1) may provide indications (e.g., in a MAC header of data or control frame) that indicate whether the TXOP of STA1 is preemptible. Accordingly, other STAs associated with the AP may use such indications to determine preemption permission from the STA before preempting the TXOP of STA1.

Furthermore, STA2 and STA3 may be UHR STAs that are associated with the AP but may be nodes hidden from each other. This means that STA2 and STA3 are not able to hear each other, but are able to hear the frame exchanges between STA1 and the AP. As STA1 performs UL transmissions to the AP in its TXOP, a PDT 1602 may start at time T3 after a UL transmission 1604 (e.g., MPDU 1-1) has been sent by the STA1 to the AP on a channel and the channel becomes idle. This is because the preemption permission indication is carried in the MAC headers of the MPDU sent by STA1. In this instance, the indicator in the MPDU may indicate that the TXOP of STA1 is preemptible.

After STA2 and STA3 hear the MPDU 1-1 and become aware of the PDT 1602, STA2 and STA3 may simultaneously send an HPPR 1606 and an HPPR 1608 in xIFS (e.g., SIFS), respectively, to the AP to indicate that they both have high priority and/or low latency data to be sent to the AP. For example, STA2 and STA3 may have both received high priority and/or low latency data (e.g., from an upper layer) and need to preempt the subsequent UL transmission from STA1 in the TXOP owned by STA1. In such an example, each of STA2 and STA3 may set an identifier in their respective HPPR (e.g., in the U-SIG of the HPPR) to identify themselves to the AP and/or other STAs. However, the HPPR 1606 and HPPR 1608 sent by STA2 and STA3 may collide with each other, resulting in the AP being able to receive the preamble of HPPPs only but unable to decode the received HPPRs (e.g., unable to decode the U-SIG fields of the HPPRs) to identify the sending STA.

At this point, the AP may take over the control of the TXOP and send a BA frame 1610 to STA1 to acknowledge the reception of the UL transmission (e.g., MPDU 1-1) from STA1. In some implementations, the BA frame 1610 may carry an indication that a trigger frame will immediately follow. In other implementations, instead of the BA frame 1610, the AP may transmit another type of signal to STA1 to indicate that a trigger frame will immediately follow. Thus, after successfully receiving the BA frame 1610 or the other type of signal, STA1 may stay in a listening mode to receive the trigger frame.

Subsequently, the AP may follow up the BA frame 1610 with a trigger frame 1612 to schedule the UL transmissions of STA2 and STA3 on Rus that are different than the RU allocated to STA1. Thus, after STA1, STA2, and STA3 receive and successfully decode the trigger frame 1612, STA1 may continue transmission of TB PPDU 1614 carrying MPDU 1-2 on the allocated RU. However, STA2 and STA3 have to simultaneously use UL OFDMA random access (UORA) to transmit on the assigned Rus TB PPDUs 1616 and 1618 that carry their MPDU 2 and MPDU 3, respectively. This means that the high priority and/or low latency data are transmitted by the STA2 and STA3 to the AP on a random basis. In response, the AP may send a BA frame 1620 that acknowledges the reception of data from STA1, STA2, and STA3. Alternatively, STA2 and STA3 may use the BSRP/BSR mechanism or the neighbor discovery protocol (NDP) feedback report poll (NFRP)/NFR mechanism to further identify themselves to the AP before transmitting high priority and/or low latency data, such that the AP may arrange subsequent UL transmission times for the transmission of the high priority and/or low latency data of STA2 and STA3 to the AP. However, if STA2 is unable to successfully receive and decode the trigger frame 1612, STA2 is prohibited from transmitting its high priority and/or low latency data. Likewise, if STA3 is unable to successfully receive and decode the trigger frame 1612, STA3 is prohibited from transmitting its high priority and/or low latency data. Nevertheless, if STA1 is unable to successfully receive and decode the trigger frame 1612, STA1 can continue its UL transmission when the channel is idle in SIFS time.

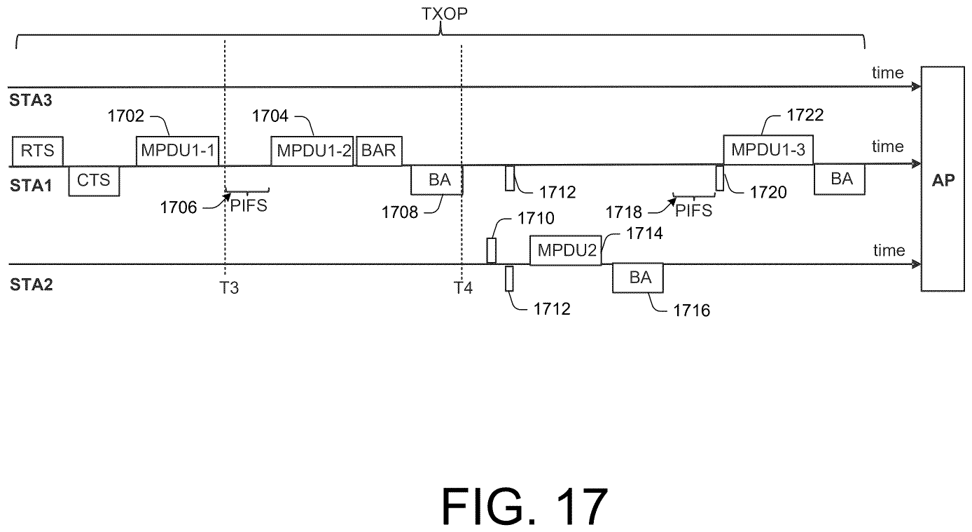

FIG. 17 illustrates a third example of preemptive access in the middle of a TXOP in which the non-TXOP holder STAs are hidden from the TXOP holder STA. As shown in FIG. 17, STAI may be performing UL transmissions to the AP, and STA1 and the AP may have an agreement that the TXOP of STA1 may be preempted and an UL transmission of STA1 or a DL transmission of the AP (e.g., BA) may be deferred if needed via the use of PDT. In this example, an STA (e.g., STA1) or the AP may provide indications (e.g., in a MAC header of data or control frame) that indicate whether the TXOP of STA1 is preemptible. Accordingly, other STAs associated with the AP may use such indications to determine preemption permission from the STA or the AP before preempting the TXOP of STA1. STA1 may include an indication of More Data in the MAC header of UL transmission to indicate the subsequent UL transmission.

Furthermore, STA2 and STA3 may be UHR STAs that are associated with the AP but are hidden nodes to STA1. This means that STA2 and STA3 are able to hear a frame sent by the AP but are unable to hear the frames sent by STA1.

Thus, as STA1 performs UL transmissions to the AP in its TXOP and sends MPDU 1-1 1702 to the AP via a channel, STA2 and STA 3 are unable to hear the MPDU 1-1 1702 that has the preemption permission indication. As a result, even if STA2 or STA3 has high priority and/or low latency data to be sent to the AP, they are unable to preempt the subsequent UL transmission by STA1 in the TXOP owned by STA1 by sending one or more HPPRs for any of their high priority and/or low latency data in the time gap (i.e., PDT) between the MPDU 1-1 1702 and the MPDU 1-2 1704. On the other hand, because STA1 did not receive any HPPR during the PDT 1706, i.e., PIFS period, that starts at time T3 after the end of MPDU 1-1 1702 (at which time the channel becomes idle), STA1 may perform a PIFS continuation and continue with the subsequent UL transmission of MPDU 1-2 1704 if STA1 indicates there is more data in the MAC header of MDPU 1-1 1702. Furthermore, If no HPPR is received in PDT and STA1 does not indicate More Data in the MAC header of MPDU 1-1 1702, the AP may transmit a BA 1708 in PIFS after the end of MPDU 1-1 1702.

In a situation in which STA1 indicates there is more data in the MAC header of MDPU 1-1 1702, such continued subsequent UL transmission may result in the AP sending a BA frame 1708 in response to the transmission of MPDU 1-2 1704, in which the BA frame 1708 may include an indication of preemption permission. Thus, as the channel becomes idle at T4, STA2 may receive the indication of preemption permission carried in the BA frame 1708 and send a HPPR 1710. After receiving the HPPR 1710 from STA2, the AP may transmit a RTPR 1712 to STA2 and/or STA1 to indicate that preemption of the TXOP owned by STA1 is permitted. After STA2 successfully receives the HPPR 1712, STA2 may send the high priority and/or low latency data 1714 (e.g., MPDU 2) to the AP. In response, the AP may send a BA frame 1716 with an indication of preemption permission and start another PDT period 1718. However, because STA2 has no further high priority and/or low latency data to send, the PDT period 1718 may expire in PIFS time without STA1 or the AP receiving any additional HPPR. Accordingly, the AP may send a response signal (e.g., RTPR) 1720 to STA1 to indicate to STA1 that STA1 may continue its subsequent UL transmission 1722 (e.g., MPDU 1-3) to the AP. Such sending of the response signal 1720 to STA1 may be considered an additional part of the PIFS continuation procedure.

In the various implementations, an HPPR that originates from a STA may include the following parameters: (1) a BSS color, which is the BSS color code received from a beacon frame of the BSS; (2) an DL/UL indicator, which indicates whether HPPR is for an uplink transmission or a downlink transmission, and in most instances is configured to indicate UL; (3) STA identification information; and (4) a preemption priority, which provides priority information of the preemption that is requested, such as the priority for low latency transmission, in-device coexistence, roaming, etc. In turn, an RTPR that is sent from an AP in response to an HPPR may include the following parameters: (1) a BSS color field that is set to the BSS color previously indicated in the HPPR; (2) an DL/UL indicator, which indicates whether RTPR is for an uplink transmission or a downlink transmission, and in most instances is configured to indicate DL; (3) STA identification information of the STA that was previously sent in the HPPR; and (4) preemption control information, which may indicate that no preemption request is received, preemption request is accepted, or that a trigger frame will follow the RTPR. However, in case of PIFS continuation, the STA identification information in a RTPR that is sent by the AP may be set to null or a station 1.

### Illustrative Implementations

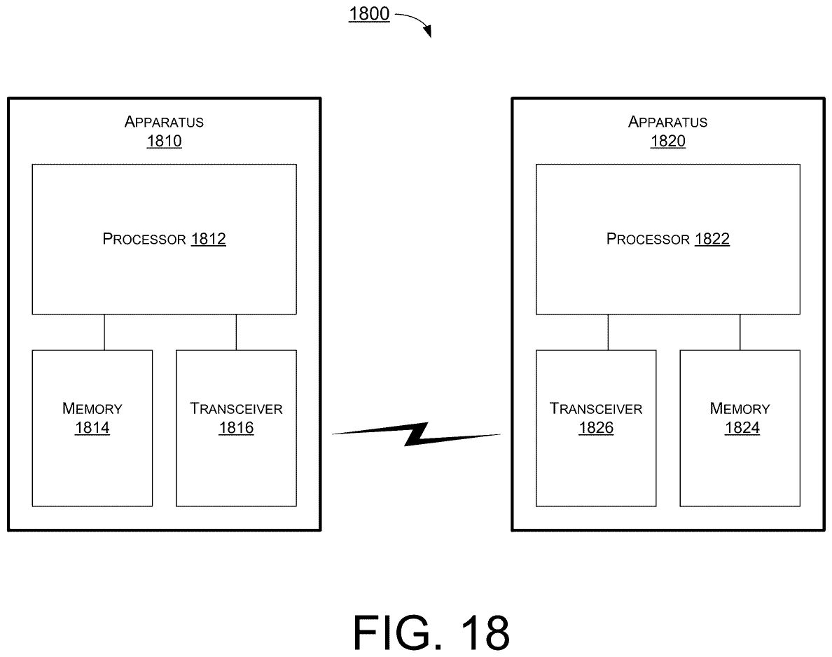

FIG. 18 illustrates an example system 1800 having at least an example apparatus 1810 and an example apparatus 1820 in accordance with an implementation of the present disclosure. Each of apparatus 1810 and apparatus 1820 may perform various functions to implement schemes, techniques, processes and methods described herein pertaining to improvements in the implementation of TXOP control transfer for Wi-Fi STAs and APs, including the various schemes described above with respect to various proposed designs, concepts, schemes, systems and methods described above as well as processes described below. For instance, apparatus 1810 may be implemented in an STA (e.g., STAs 102, 104, 106, 108) and apparatus 1820 may be implemented in AP 110, or vice versa.

Each of apparatus 1810 and apparatus 1820 may be a part of an electronic apparatus, such as a portable or mobile apparatus, a wearable apparatus, a wireless communication apparatus or a computing apparatus. When implemented in a STA, each of apparatus 1810 and apparatus 1820 may be implemented in a smartphone, a smart watch, a personal digital assistant, a digital camera, or a computing equipment such as a tablet computer, a laptop computer or a notebook computer. Each of apparatus 1810 and apparatus 1820 may also be a part of a machine type apparatus, which may be an IoT apparatus such as an immobile or a stationary apparatus, a home apparatus, a wire communication apparatus or a computing apparatus. For instance, each of apparatus 1810 and apparatus 1820 may be implemented in a smart thermostat, a smart fridge, a smart door lock, a wireless speaker, or a home control center. When implemented in or as a network apparatus, apparatus 1810 and/or apparatus 1820 may be implemented in a network node, such as an AP in a WLAN or a mesh device.

In some implementations, each of apparatus 1810 and apparatus 1820 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1810 and apparatus 1820 may be implemented in or as a STA or an AP. Each of apparatus 1810 and apparatus 1820 may include at least some of those components shown in FIG. 18 such as a processor 1812 and a processor 1822, respectively, for example. Each of apparatus 1810 and apparatus 1820 may further include one or more other components not pertinent to the proposed scheme of the present disclosure (e.g., internal power supply, display device and/or user interface device), and, thus, such component(s) of apparatus 1810 and apparatus 1820 are neither shown in FIG. 18 nor described below in the interest of simplicity and brevity.

In one aspect, each of processor 1812 and processor 1822 may be implemented in the form of one or more single-core processors, one or more multi-core processors, one or more RISC processors or one or more CISC processors. That is, even though a singular term “a processor” is used herein to refer to processor 1812 and processor 1822, each of processor 1812 and processor 1822 may include multiple processors in some implementations and a single processor in other implementations in accordance with the present disclosure. In another aspect, each of processor 1812 and processor 1822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1812 and processor 1822 is a special-purpose machine specifically designed, arranged and configured to perform specific tasks including those pertaining to TXOP control transfer for Wi-Fi STAs and APs in accordance with various implementations of the present disclosure.

In some implementations, apparatus 1810 may also include a transceiver 1816 coupled to processor 1812. Transceiver 1816 may include a transmitter capable of wirelessly transmitting and a receiver capable of wirelessly receiving data. In some implementations, apparatus 1820 may also include a transceiver 1826 coupled to processor 1822. Transceiver 1826 may include a transmitter capable of wirelessly transmitting and a receiver capable of wirelessly receiving data. It is noteworthy that, although transceiver 1816 and transceiver 1826 are illustrated as being external to and separate from processor 1812 and processor 1822, respectively, in some implementations, transceiver 1816 may be an integral part of processor 1812 as a system on chip (SoC) and/or transceiver 1826 may be an integral part of processor 1822 as a SoC.

In some implementations, apparatus 1810 may further include a memory 1814 coupled to processor 1812 and capable of being accessed by processor 1812 and storing data therein. In some implementations, apparatus 1820 may further include a memory 1824 coupled to processor 1822 and capable of being accessed by processor 1822 and storing data therein. Each of memory 1814 and memory 1824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1814 and memory 1824 may include a type of read-only memory (ROM) such as mask ROM, programmable ROM (PROM), erasable programmable ROM (EPROM) and/or electrically erasable programmable ROM (EEPROM). Alternatively, or additionally, each of memory 1814 and memory 1824 may include a type of non-volatile random-access memory (NVRAM) such as flash memory, solid-state memory, ferroelectric RAM (FeRAM), magnetoresistive RAM (MRAM) and/or phase-change memory.

Each of apparatus 1810 and apparatus 1820 may be a communication entity capable of communicating with each other using various proposed schemes in accordance with the present disclosure. For illustrative purposes and without limitation, a description of capabilities of apparatus 1810 or apparatus 1820, as an STA (e.g., STAs 102, 104, 106, 108) or AP 110 is provided below in the context of example processes 1900-2100. It is noteworthy that, although a detailed description of capabilities, functionalities and/or technical features of either of apparatus 1810 and apparatus 1820 is provided below, the same may be applied to the other of apparatus 1810 and apparatus 1820 although a detailed description thereof is not provided solely in the interest of brevity. It is also noteworthy that, although the example implementations described below are provided in the context of WLAN, the same may be implemented in other types of networks.

### Illustrative Processes

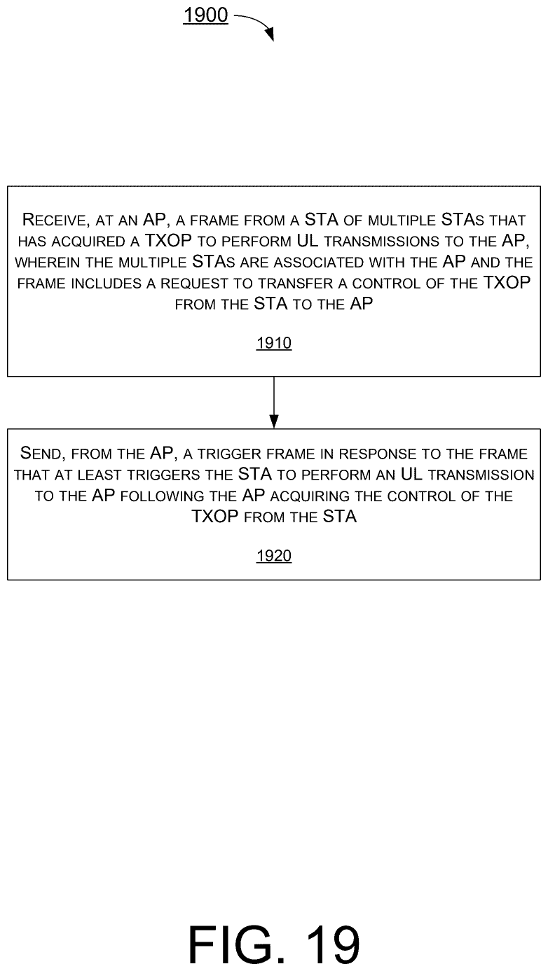

FIG. 19 illustrates an example process 1900 in accordance with an implementation of the present disclosure. Process 1900 may represent an aspect of implementing various proposed designs, concepts, schemes, systems, and methods described above. More specifically, process 1900 may represent an aspect of the proposed concepts and schemes pertaining to TXOP control transfer for Wi-Fi STAs and APs. Process 1900 may include one or more operations, actions, or functions as illustrated by one or more of blocks 1910 and 1920. Although illustrated as discrete blocks, various blocks of process 1900 may be divided into additional blocks, combined into fewer blocks, or eliminated, depending on the desired implementation. Moreover, the blocks/sub-blocks of process 1900 may be executed in the order shown in FIG. 19 or, alternatively in a different order. Furthermore, one or more of the blocks/sub-blocks of process 1900 may be executed repeatedly or iteratively. Process 1900 may be implemented by or in apparatus 1810 and apparatus 1820 as well as any variations thereof. Solely for illustrative purposes and without limiting the scope, process 1900 is described below in the context of apparatus 1810 implemented in or as a station (e.g., STA 102) and apparatus 1820 implemented in or as an AP of a wireless network such as a WLAN in network environment 100 in accordance with one or more of IEEE 802.11 standards. Process 1900 may begin at block 1910.

At 1910, process 1900 may include processor 1822 of apparatus 1820 that is implemented as an AP receiving, at apparatus 1820 a frame from a STA of multiple STAs that has acquired a TXOP to perform UL transmissions to apparatus 1820, wherein the multiple STAs are associated with apparatus 1820 and the frame includes a request to transfer a control of the TXOP from the STA to apparatus 1820. Process 1000 may proceed from 1910 to 1920.

At 1920, process 1900 may include processor 1822 sending, from apparatus 1820, a trigger frame that at least triggers the STA to perform an UL transmission to apparatus 1820 following apparatus 1820 acquiring the control of the TXOP from the STA.

In some implementations, the trigger frame may further trigger an additional STA of the multiple STAs to perform an additional UL transmission to apparatus 1820 that is simultaneous with the UL transmission to apparatus 1820.

In some implementations, process 1900 may additionally include processor 1822 further sending from apparatus 1820 to an additional STA of the multiple STAs a DL transmission of low latency data that is simultaneous with the UL transmission to apparatus 1820.

In some implementations, the trigger frame may include a TXOP duration parameter that indicates at least one of indicates at least one of a remaining TXOP duration, a TXOP bandwidth parameter that indicates a bandwidth of the TXOP, a UL RU allocation parameter that indicates a RU size and RU type, a UL time allocation parameter that indicates a transmission time to be allocated to the STA during the TXOP, a buffer status that includes a queue size of the first STA, or a delay bound that is a maximum amount of time allowed for a transport of a MSDU or an A-MSDU.

In some implementations, the TXOP duration parameter may include a first value or a second value, wherein the first value indicates that a single frame exchange is allowed such that apparatus 1820 is permitted to send only one trigger frame in response to the frame, and the second value indicates that a multiple frame exchange is allowed such that apparatus 1820 is permitted to send more than one trigger frame in response to the frame. In such implementations, process 1900 may additionally include when the TXOP duration parameter includes the first value, processor 1822 receiving from the STA an additional frame from the STA during the TXOP, the additional frame indicating that the STA has no additional UL traffic to transmit to apparatus 1820, and in response to the receiving, sending an additional trigger frame that triggers another STA of the multiple STAs to send another UL transmission to apparatus 1820 during the TXOP. However, when the TXOP duration parameter includes the second value, processor 1822 may at least send from apparatus 1820 an additional trigger frame during the TXOP that triggers the STA to send another UL transmission to apparatus 1820.

In some implementations, process 1900 may additionally include, when the TXOP duration parameter includes the first value, processor 1822 receiving, at apparatus 1820, an CF-end frame from the STA during the TXOP that terminates the TXOP. However, when the TXOP duration parameter includes the second value, processor 1822 may send from apparatus 1820 to at least the STA during TXOP a CF-end frame that terminates the TXOP.

In some implementations, process 1900 may additionally include processor 1822 exchanging control information between apparatus 1820 and one or more other STAs prior to the sending of the trigger frame that at least triggers the STA to perform the UL transmission to apparatus 1820.

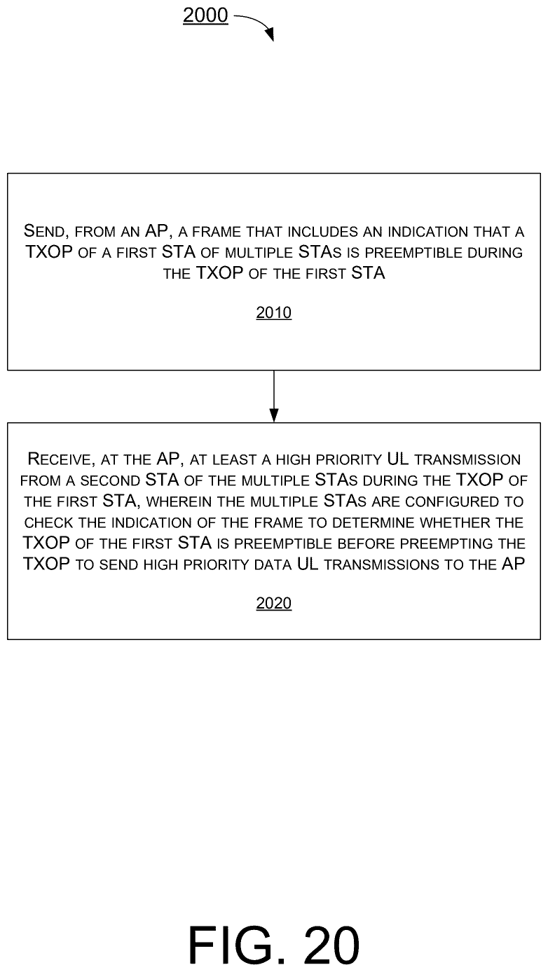

FIG. 20 illustrates an example process 2000 in accordance with an implementation of the present disclosure. Process 2000 may represent an aspect of implementing various proposed designs, concepts, schemes, systems, and methods described above. More specifically, process 2000 may represent an aspect of the proposed concepts and schemes pertaining to TXOP control transfer for Wi-Fi STAs and APs. Process 2000 may include one or more operations, actions, or functions as illustrated by one or more of blocks 2010 and 2020. Although illustrated as discrete blocks, various blocks of process 2000 may be divided into additional blocks, combined into fewer blocks, or eliminated, depending on the desired implementation. Moreover, the blocks/sub-blocks of process 2000 may be executed in the order shown in FIG. 20 or, alternatively in a different order. Furthermore, one or more of the blocks/sub-blocks of process 2000 may be executed repeatedly or iteratively. Process 2000 may be implemented by or in apparatus 1810 and apparatus 1820 as well as any variations thereof. Solely for illustrative purposes and without limiting the scope, process 2000 is described below in the context of apparatus 1810 implemented in or as a station (e.g., STA 102) and apparatus 1820 implemented in or as an AP of a wireless network such as a WLAN in network environment 100 in accordance with one or more of IEEE 802.11 standards. Process 2000 may begin at block 2010.

At 2010, process 2000 may include processor 1822 of apparatus 1820 implemented as an AP sending, from apparatus 1820 a frame that includes an indication that a TXOP of the first STA of multiple STAs is preemptible during the TXOP of the first STA. Process 2000 may proceed from 2010 to 2020.

At 2020, process 2000 may include processor 1822 receiving, at apparatus 1820, at least a UL transmission from a second STA of the multiple STAs during the TXOP of the first STA, wherein the multiple STAs are configured to check the indication of the frame to determine whether the TXOP of the first STA is preemptible before preempting the TXOP to send high priority UL transmissions to apparatus 1820.

In some implementations, the sending includes sending the frame following a UL transmission by the first STA to apparatus 1820, and wherein the receiving includes processor 1822 performing operations that include receiving, at apparatus 1820 during a PDT that follows the sending of the frame, a HPPR from the second STA of the multiple STAs to preempt the TXOP of the first STA, sending, from apparatus 1820 to at least the first STA and the second STA in response to the HPPR, a RTPR or a trigger frame, wherein the RTPR or the trigger frame at least causes the second STA to preempt the TXOP of the first STA and send a high priority UL transmission to apparatus 1820 during the TXOP of the first STA, and receiving at least the high priority UL transmission at apparatus 1820 during the TXOP of the first STA. In some implementations, the RTPR may cause the first STA to defer a subsequent UL transmission of the first STA to apparatus 1820 to after the high priority UL transmission of the second STA to apparatus 1820, and the trigger frame may cause the second STA to send the high priority UL transmission to apparatus 1820 on a second channel and the first STA to simultaneously send a subsequent UL transmission of the first STA to apparatus 1820 on a first channel.

In some implementations, the multiple STAs further include a third STA in which the third STA and the second STA have pending UL data for transmission at same time, and processor 1822 may further simultaneously receive at apparatus 1820 during the PDT that follows the sending of the frame, an additional HPPR from the third STA such that apparatus 1820 is unable to identify a sending STA due to collision between the HPPR and the additional HPPR, and wherein the sending by processor 1822 may include sending a trigger frame to the first STA, the second STA, and the third STA that triggers the first STA to send an additional UL transmission on an allocated RU to apparatus 1820, and triggers the second STA and the third STA to use RUs other than the allocated RU on a random basis to send their high priority UL transmissions to apparatus 1820.

In some implementations. the sending by processor 1822 may include apparatus 1820 sending the frame that includes the indication following the first STA sending a previous frame that indicated the TXOP of the first STA is preemptible, and an expiration of a PDT period at PIFS time initiated by the first STA during which the second STA failed to send a corresponding HPPR due to an inability of the second STA to hear data traffic of the first STA. In such implementations, the sending of the frame may include apparatus 1820 sending a BA frame that includes the indication and which acknowledges an additional UL transmission that is sent by the first STA to apparatus 1820 following the expiration of the PDT period (i.e., at PIFS time).

In such implementations, process 2000 may additionally include processor 1822 performing operations that include sending, by apparatus 1820, a BA frame that includes the indication following a reception of the high priority UL transmission from the second STA at apparatus 1820, sending, by apparatus 1820, a signal for the first STA to send another UL transmission to apparatus 1820 following an expiration of another PDT period at PIFS time initiated by the BA frame during which no HPPR is received by apparatus 1820 or the first STA.

In some implementations, HPPR received at apparatus 1820 from the second STA includes a BSS color that is a color code received from a beacon frame of the BSS, a DL/UL indicator that indicates whether the HPPR is for an uplink transmission or a downlink transmission, a STA identification of the second STA, and preemption priority information of the preemption that is requested, and wherein a RTRP to the HPPR from apparatus 1820 to the second STA includes a BSS color field that is set to the BSS color indicated in the HPPR, the DL/UL indicator, the STA identification of the second STA, and preemption control information that indicates no preemption request is received, preemption request is accepted, or that a trigger frame will follow the RTPR.

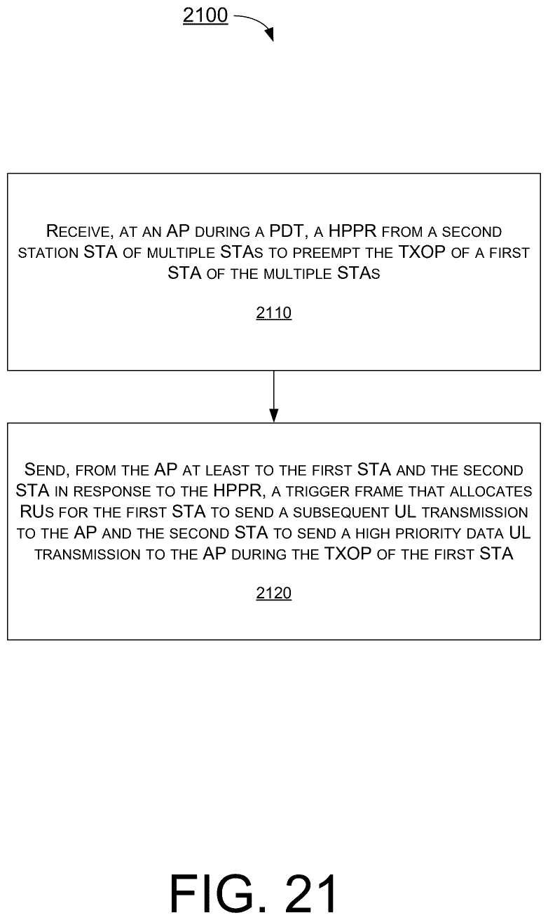

FIG. 21 illustrates an example process 2100 in accordance with an implementation of the present disclosure. Process 2100 may represent an aspect of implementing various proposed designs, concepts, schemes, systems, and methods described above. More specifically, process 2100 may represent an aspect of the proposed concepts and schemes pertaining to TXOP control transfer for Wi-Fi STAs and APs. Process 2100 may include one or more operations, actions, or functions as illustrated by one or more of blocks 2110 and 2120. Although illustrated as discrete blocks, various blocks of process 2100 may be divided into additional blocks, combined into fewer blocks, or eliminated, depending on the desired implementation. Moreover, the blocks/sub-blocks of process 2100 may be executed in the order shown in FIG. 21 or, alternatively in a different order. Furthermore, one or more of the blocks/sub-blocks of process 2100 may be executed repeatedly or iteratively. Process 2100 may be implemented by or in apparatus 1810 and apparatus 1820 as well as any variations thereof. Solely for illustrative purposes and without limiting the scope, process 2100 is described below in the context of apparatus 1810 implemented in or as a station (e.g., STA 102) and apparatus 1820 implemented in or as an AP of a wireless network such as a WLAN in network environment 100 in accordance with one or more of IEEE 802.11 standards. Process 2100 may begin at block 2110.

At 2110, process 2100 may include processor 1822 of apparatus 1820 implemented as an AP receiving during a PDT a HPPR from a second STA of multiple STAs to preempt the TXOP of a first STA of the multiple STAs. Process 2100 may proceed from 2110 to 2120.

At 2120, process 2100 may include processor 1822 sending, from apparatus 1820 at least to the first STA and the second STA in response to the HPPR, a trigger frame that allocates RUs for the first STA to send a subsequent UL transmission to apparatus 1820 and the second STA to send a high priority UL transmission to apparatus 1820 during the TXOP of the first STA.

In some implementations, a frame sent by the first STA prior to the PDT may include an indication that the TXOP of the first STA is preemptable, and the second STA is configured to check the indication in the frame to determine whether the TXOP of the first STA is preemptible before sending the HPPR request to the AP. In some implementations, process 2100 may additionally include processor 1822 of apparatus 1820 receiving the subsequent UL transmission and the high priority UL transmission at the apparatus during the TXOP of the first STA following the sending of the trigger frame.

In some implementations, the multiple STAs may further include a third STA in which the third STA and the second STA have pending UL data for transmission at same time, wherein the process 2100 may further include processor 1822 performing operations comprising simultaneously receiving at apparatus 1820 during the PDT that follows the frame being sent by the first STA, an additional HPPR from the third STA such that apparatus 1820 is unable to identify a sending STA due to collision between the HPPR and the additional HPPR, and the sending includes sending the trigger frame to the first STA, the second STA, and the third STA that triggers the first STA to send the subsequent UL transmission on an allocated RU to apparatus 1820, and triggers the second STA and the third STA to use RUs other than the allocated RU on a random basis to send their high priority UL transmissions to apparatus 1820.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. An apparatus, comprising:
a transceiver configured to communicate wirelessly; and
a processor coupled to the transceiver and configured to perform operations comprising:
receiving, at the apparatus, a frame from a station (STA) of multiple STAs that has acquired a transmission opportunity (TXOP) to perform uplink (UL) transmissions to the apparatus, wherein the multiple STAs are associated with the apparatus and the frame includes a request to transfer a control of the TXOP from the STA to the apparatus; and
sending, from the apparatus, a trigger frame in response to the frame that at least triggers the STA to perform an UL transmission to the apparatus following the apparatus acquiring the control of the TXOP from the STA.

2. The apparatus of claim 1, wherein the trigger frame further triggers an additional STA of the multiple STAs to perform an additional UL transmission to the apparatus that is simultaneous with the UL transmission to the apparatus.

3. The apparatus of claim 1, wherein the processor is configured to perform further operations comprising, sending from the apparatus to an additional STA of the multiple STAs a downlink (DL) transmission of low latency data that is simultaneous with the UL transmission to the apparatus.

4. The apparatus of claim 1, wherein the trigger frame triggers the STA to perform the UL transmission to the apparatus using a distributed resource unit (D-RU) based trigger-based (TB) physical protocol data unit (PPDU).

5. The apparatus of claim 1, wherein the trigger frame includes a TXOP duration parameter that indicates at least one of a remaining TXOP duration, a TXOP bandwidth parameter that indicates a bandwidth of the TXOP, a UL resource unit (RU) allocation parameter that indicates a RU size and RU type, a UL time allocation parameter that indicates a transmission time to be allocated to the STA during the TXOP, a buffer status that includes a queue size of the STA, or a delay bound that is a maximum amount of time allowed for a transport of a MAC service data unit (MSDU) or an aggregate MSDU (A-MSDU).

6. The apparatus of claim 5, the TXOP duration parameter includes a first value or a second value, wherein the first value indicates that a single frame exchange is allowed such that the apparatus is permitted to send only one trigger frame in response to the frame, and the second value indicates that a multiple frame exchange is allowed such that the apparatus is permitted to send more than one trigger frame in response to the frame.

7. The apparatus of claim 6, wherein the processor is configured to perform further operations comprising:
when the TXOP duration parameter includes the first value, receiving from the STA an additional frame from the STA during the TXOP, the additional frame indicating that the STA has no additional UL traffic to transmit to the apparatus, and in response to the receiving, sending an additional trigger frame that triggers another STA of the multiple STAs to send another UL transmission to the apparatus during the TXOP; or
when the TXOP duration parameter includes the second value, at least sending from the apparatus an additional trigger frame during the TXOP that triggers the STA to send another UL transmission to the apparatus.

8. The apparatus of claim 6, wherein the processor is configured to perform further operations comprising:
when the TXOP duration parameter includes the first value, receiving, at the apparatus, an CF-end frame from the STA during the TXOP that terminates the TXOP; or
when the TXOP duration parameter includes the second value, sending from the apparatus to at least the STA during TXOP a CF-end frame that terminates the TXOP.

9. The apparatus of claim 1, wherein the processor is configured to perform further operations comprising exchanging control information between the apparatus and one or more other STAs prior to the sending of the trigger frame that at least triggers the STA to perform the UL transmission to the apparatus.

10. A method, comprising:
sending, from an access point (AP), a frame that includes an indication that a transmission opportunity (TXOP) of a first station STA of multiple STAs is preemptible during the TXOP of the first STA; and
receiving, at the AP, at least a high priority uplink (UL) transmission from a second STA of the multiple STAs during the TXOP of the first STA, wherein the multiple STAs are configured to check the indication of the frame to determine whether the TXOP of the first STA is preemptible before preempting the TXOP to send high priority UL transmissions to the AP.

11. The method of claim 10, wherein the sending includes sending from the AP the frame following a UL transmission by the first STA to the AP, and wherein the receiving includes:
receiving, at the AP during a preemption detection time (PDT) that follows the sending of the frame, a high priority preemption request (HPPR) from the second STA of the multiple STAs to preempt the TXOP of the first STA;
sending, from the AP to at least the first STA and the second STA in response to the HPPR, a response to preemption request (RTPR) or a trigger frame, wherein the RTPR or the trigger frame at least causes the second STA to preempt the TXOP of the first STA and send a high priority UL transmission to the AP during the TXOP of the first STA; and
receiving at least the high priority UL transmission at the AP during the TXOP of the first STA.

12. The method of claim 11, wherein the RTPR further causes the first STA to defer a subsequent UL transmission of the first STA to the AP to after the high priority UL transmission of the second STA to the AP, and wherein the trigger frame further causes the second STA to send the high priority UL transmission to the AP on a second channel and the first STA to simultaneously send a subsequent UL transmission of the first STA to the AP on a first channel.

13. The method of claim 11, wherein the multiple STAs further include a third STA in which the third STA and the second STA have pending UL data for transmission at same time, further comprising simultaneously receiving at the AP during the PDT that follows the sending of the frame, an additional HPPR from the third STA such that the AP is unable to identify a sending STA due to collision between the HPPR and the additional HPPR, and wherein the sending includes sending a trigger frame to the first STA, the second STA, and the third STA that triggers the first STA to send an additional UL transmission on an allocated resource unit (RU) to the AP, and triggers the second STA and the third STA to use RUs other than the allocated RU on a random basis to send their high priority UL transmissions to the AP.

14. The method of claim 11, wherein the sending the frame includes the AP sending the frame that includes the indication following the first STA sending a previous frame that indicated the TXOP of the first STA is preemptible, and an expiration of a PDT period at point coordination function inter-frame space (PIFS) time initiated by the first STA during which the second STA failed to send a corresponding HPPR due to an inability of the second STA to hear data traffic of the first STA.

15. The method of claim 14, wherein the sending the frame includes the AP sending a block acknowledgment (BA) frame that includes the indication and which acknowledges an additional UL transmission that is sent by the first STA to the AP following the expiration of the PDT period.

16. The method of claim 14, further comprising:
sending, by the AP, a BA frame that includes the indication following a reception of the high priority UL transmission from the second STA at the AP; and
sending, by the AP, a signal for the first STA to send another UL transmission to the AP following an expiration of another PDT period at PIFS time initiated by the BA frame during which no HPPR is received by the AP or the first STA.

17. The method of claim 11, wherein the HPPR received at the AP from the second STA includes a basic service set (BSS) color that is a color code received from a beacon frame of the BSS, a downlink (DL)/UL indicator that indicates whether the HPPR is for an UL transmission or a DL transmission, STA identification of the second STA, and a preemption priority of a preemption that is requested, and wherein the RTRP to the HPPR from the AP to the second STA includes a BSS color field that is set to the BSS color indicated in the HPPR, the DL/UL indicator, the STA identification of the second STA, and preemption control information that indicates no preemption request is received, preemption request is accepted, or that a trigger frame will follow the RTPR.

18. A method, comprising:
receiving at an access point (AP) during a preemption detection time (PDT) a high priority preemption request (HPPR) from a second station (STA) of multiple STAs to preempt a transmission opportunity (TXOP) of a first STA of the multiple STAs; and
sending, from the AP at least to the first STA and the second STA in response to the HPPR, a trigger frame that allocates RUs for the first STA to send a subsequent UL transmission to the AP and the second STA to send a high priority UL transmission to the AP during the TXOP of the first STA.

19. The method of claim 18, wherein a frame sent by the first STA prior to the PDT includes an indication that the TXOP of the first STA is preemptable, and the second STA is configured to check the indication in the frame to determine whether the TXOP of the first STA is preemptible before sending the HPPR request to the AP, further comprising receiving the subsequent UL transmission and the high priority UL transmission at the AP during the TXOP of the first STA following the sending of the trigger frame.

20. The method of claim 19, wherein the multiple STAs further include a third STA in which the third STA and the second STA have pending UL data for transmission at same time, further comprising simultaneously receiving at the AP during the PDT that follows the frame being sent by the first STA, an additional HPPR from the third STA such that the AP is unable to identify a sending STA due to collision between the HPPR and the additional HPPR, and wherein the sending includes sending the trigger frame to the first STA, the second STA, and the third STA that triggers the first STA to send the subsequent UL transmission on an allocated RU to the AP, and triggers the second STA and the third STA to use RUs other than the allocated RU on a random basis to send their high priority UL transmissions to the AP.
